(19) United States
(12) Patent Application Publication
(10) Pub. No.: US 2009/0238061 A1
(43) Pub. Date: Sep. 24, 2009

(54) OPTICAL PICKUP APPARATUS AND OPTICAL INFORMATION RECORDING REPRODUCING APPARATUS

(76) Inventors: Yuichi Atarashi, Tokyo (JP); Tohru Kimura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/661,857

(22) PCT Filed: Sep. 15, 2006
(86) PCT No.: PCT/JP2006/318328

§ 371 Date: Mar. 5, 2007

(30) Foreign Application Priority Data
Sep. 27, 2005 (JP) 2005-279641

(51) Int. Cl. G11B 7/135

(52) U.S. Cl. 369/112.02; G9B/7.112

(57) ABSTRACT

A structure according to the present invention is an optical pickup apparatus including a first light source, a second light source, a third light source, a first objective optical system, a second objective optical system, an incidence optical system for emitting the first to third light fluxes into the first objective optical system or the second objective optical system, and an optical detector. The optical pickup apparatus converges a light flux emitted from the first light source onto an information recording surface of a first optical information recording medium or a second optical information recording medium, by using the first objective optical system. The optical pickup apparatus converges a light flux emitted from the second light source onto an information recording surface of a third optical information recording medium by using the second objective optical system, and further converges a light flux emitted from the third light source onto an information recording surface of a fourth optical information recording medium by using the second objective optical system. The first objective optical system includes an objective lens, and a liquid crystal correcting element being adopted to correct the amount of spherical aberration for a light flux passing through the liquid crystal correcting element.

### TECHNICAL FIELD

The present invention relates to an optical pickup apparatus for recording and/or reproducing information for at least four kinds of optical information recording media.

### BACKGROUND ART

In recent years, tendency of a shorter wavelength of laser beam as a light source which has been used to record and/or reproduce information for optical discs, has become a main stream. For example, a laser light source having 400-420 nm wavelength, such as a blue-violet semiconductor laser; and a blue-SHG laser which converts wavelength of an infrared semiconductor laser utilizing a second harmonic, have been made practical.

Information of 15-20 GB can be recorded on the optical disk having a diameter of 12 cm by using these blue-violet optical sources and an objective lens having NA (Numerical aperture) which is the same as a DVD (Digital Versatile Disc). When NA is increased to 0.85, information of 23-25 GB can be recorded onto the optical disk having a diameter of 12 cm. In this specification, the optical disk and an optical-magnetic disk using a blue-violet laser light source are called “a high density optical disk”.

At this moment, two industrial standards for the high density optical disk have been proposed. One is Blu-ray disc (it will be called BD hereinafter) having a protective substrate with a thickness of 0.1 mm for which an objective lens having a NA 0.85 is used, and the other is HD DVD (it will be called HD hereinafter) having a protective substrate with a thickness of 0.6 mm for which the objective lens having a NA 0.65-0.67 is used. A high density optical disk player/recorder capable of recording and/or reproducing information for both high density discs will be required based on an assumption that these two high density discs based on these two industrial standards will become popular in a market in future.

On the other hand, it is sometimes considered that a product, such as an optical disk player/recorder, which is capable of only recording/reproducing information for a high-density optical disk is worthless. Taking account of a fact that, at present, DVDs and CDs (compact disc), onto which various kinds of information have been recorded, are on the market, the value of the product as a high-density optical disk player/recorder is increased by, for example, enabling to appropriately record/reproduce information additionally for DVDs and CDs, which a user possesses. From these backgrounds, the optical pickup apparatus installed in the high-density optical disk player/recorder is required to be capable of appropriately recording/reproducing information not only for a high-density optical disk but also a DVD and a CD.

However, when a common objective lens is used for conducting recording and/or reproducing of information compatibly for BD and HD, a degree of freedom for design of the objective lens is restricted because of difference in standards such as numerical aperture NA and protective substrate thickness between BD and HD, resulting in causing a problem of deteriorations in temperature characteristics. In contrast to this, the following Patent Document 1 discloses an optical pickup apparatus that can conduct recording and/or reproducing of information compatibly while securing a degree of freedom for design, by providing two objective lenses respectively for BD and HD.

However, the optical pickup apparatus in Patent Document 1 has a problem that since independent light sources are respectively provided for two objective lens, the structure of the optical pickup apparatus becomes complicated and the size of the optical pickup apparatus becomes large. Further, in order to compatibly record and/or reproduce information for DVD and CD in addition to BD and HD, there is provided a problem that how to combine three kinds of light fluxes having different wavelengths and two objective lenses.

There has already been DVD/CD compatible objective lens for converging infrared laser light flux onto the information recording surface of CD and converging red laser light flux onto the information recording surface of DVD, on the market. Accordingly, it becomes possible to manufacture the optical pickup apparatus, which is capable of recording and/or reproducing information for four different kinds of optical discs, in a low cost by combining an objective lens for converging blue-violet laser light flux onto the information recording surface of BD and HD and the DVD/CD compatible objective lens, which has been already on the market.

However, as described above, BD and HD have the protective layers with the different thickness. Therefore, when utilizing the same objective lens for them, it is necessary to provide the method for correcting spherical aberration caused by the thickness difference. Here, when the wavelengths of the light fluxes used in the optical pickup apparatus are different from each other like DVD and CD, a diffractive structure can be used for efficiently correcting a spherical aberration caused by the thickness difference. However, when recording and/or reproducing information for BD and HD, the same wavelength of blue-violet laser light flux is used for them. Therefore, there is a problem that, when splitting the light amount into, for example, the half of the light amount which is used for BD and the other half of the light amount which is used for HD, the light intensity of the converging light spot decreases. In the case of the optical pickup apparatus for recording and/or recording information onto the optical disk with a double speed, it tends to occur reading errors and/or writing errors.

On the other hand, it is also possible to correct the spherical aberration caused by the thickness difference between BD and HD by shifting a coupling lens in an optical axis direction. However, in the case of the optical pickup apparatus used in a notebook PC, a thin type of structure is required. And there is a further request for using an optical element such as a coupling lens as a stable element if possible.

Patent Document 1: Japanese Patent Application Open to Public Inspection No. 2004-295983

### DISCLOSURE OF THE INVENTION

The present invention has been achieved in view of the problems stated above, and one of its object is to provide an optical pickup apparatus including an objective lens that is simple and small in size and can conduct recording and/or reproducing information properly for four high density optical discs each used under the different standards.

A preferred embodiment according to the present invention is an optical pickup apparatus including: a first light source; a second light source; a third light source; a first objective optical system; and a second objective optical system. The optical pickup apparatus further includes an incidence optical system for emitting the first through third light fluxes into the first objective optical system or the second objective optical system; and an optical detector. In the optical pickup apparatus, the first objective optical system is adopted to converge the first light flux emitted by the first light source onto an information recording surface of a first optical information recording medium so that the optical pickup apparatus can conduct reproducing and/or recording information for the first optical information recording medium. In the optical pickup apparatus, the first objective optical system is further adopted to converge the first light flux onto an information recording surface of a second optical information recording medium so that the optical pickup apparatus can conduct reproducing and/or recording information for the second optical information recording medium. In the optical pickup apparatus, the second objective optical system is adopted to converge the second light flux emitted by the second light source onto an information recording surface of the third optical information recording medium so that the optical pickup apparatus can conduct reproducing and/or recording information for the third optical information recording medium. In the optical pickup apparatus, the second objective optical system is further adopted to converge the third light flux emitted by the third light flux onto an information recording surface of the fourth optical information recording medium so that the optical pickup apparatus can conduct reproducing and/or recording information for the fourth optical information recording medium. The first objective optical system includes an objective lens and a liquid crystal correction element. The liquid crystal correction element is adopted to correct an amount of spherical aberration of the light flux passing through the liquid crystal correction element. The incidence optical system includes a predetermined optical element.

### BRIEF DESCRIPTION OF DRAWINGS

FIG. 1 illustrates a schematic cross sectional view of the optical pickup apparatus of the first embodiment of the present invention.

FIG. 2 illustrates a perspective view of the objective lens actuator apparatus, which is used for the optical pickup apparatus of the embodiment.

FIG. 3 illustrates a cross sectional view of a schematic structure of a liquid crystal correction element LCD.

FIG. 4 illustrates a schematic cross sectional view for the optical pickup apparatus of the second embodiment of the present invention.

FIG. 5 illustrates a schematic cross sectional view for the optical pickup apparatus of the third embodiment of the present invention.

FIG. 6 illustrates a schematic cross sectional view for the optical pickup apparatus of the fourth embodiment of the present invention.

FIG. 7 illustrates a schematic cross sectional view for the optical pickup apparatus of the fifth embodiment of the present invention.

FIG. 8 illustrates a schematic cross sectional view for the optical pickup apparatus of the sixth embodiment of the present invention.

Each of FIGS. 9(a) and 9(b) illustrates a plane view showing the main portion of a phase structure.

Each of FIGS. 10(a) and 10(b) illustrates a plane view showing the main portion of a phase structure.

Each of FIGS. 11(a) and 11(b) illustrates a plane view showing the main portion of a phase structure.

Each of FIGS. 12(a) and 12(b) illustrates a plane view showing the main portion of a phase structure.

### BEST MODE FOR CARRYING OUT THE INVENTION

Concrete embodiments of the present invention will be described hereinafter.

Item 1 provides an optical pickup apparatus including a first light source for emitting a first light flux having a wavelength λ1; a second light source for emitting a second light flux having a wavelength λ2 (λ2>λ1); a third light source for emitting a third light flux having a wavelength λ3 (λ3>λ2); a first objective optical system; a second objective optical system; an incidence optical system for emitting the first to third light fluxes into one of the first objective optical system and the second objective optical system; and an optical detector. The first objective optical system is adopted to converge the first light flux with the wavelength λ1 emitted by the first light source onto an information recording surface of a first optical information recording medium having a first protective layer whose thickness is t1 so that the optical pickup apparatus conducts reproducing and/or recording information for the first optical information recording medium. The first objective optical system is further adopted to converge the first light flux onto an information recording surface of a second optical information recording medium having a second protective layer whose thickness is t2 (t2>t1) so that the optical pickup apparatus conducts reproducing and/or recording information for the second optical information recording medium. The second objective optical system is adopted to converge the second light flux with the wavelength λ2 emitted by the second light source onto an information recording surface of a third optical information recording medium having a third protective layer whose thickness is t3 (t3>t1) so that the optical pickup apparatus conducts reproducing and/or recording information for the third optical information recording medium. The second objective optical system is further adopted to converge the third light flux with the wavelength λ3 emitted by the third light flux onto an information recording surface of a fourth optical information recording medium having a fourth protective layer whose thickness is t4 (t4>t3) so that the optical pickup apparatus conducts reproducing and/or recording information for the fourth optical information recording medium. The first objective optical system includes an objective lens and a liquid crystal correction element. The liquid crystal correction element is adopted to correct an amount of a spherical aberration of a light flux passing through the liquid crystal correction element. The incidence optical system includes an optical element arranged statically along at least an optical axis.

In the structure, the light flux entering into the first objective optical system always passes through the objective lens and the liquid crystal correcting element which form the first objective optical system.

Further, the objective lens and the liquid crystal correcting element which form the first objective optical element, are held by an arbitral member to each other, or they may be formed as one body.

The objective lens forming the first objective optical system is preferably a single lens.

In this specification, optical discs, for which require a blue-violet semiconductor laser diode or a blue-violet SHG laser to record/reproduce information is called a high density optical disk. The high density optical disk includes: an optical disk, for example BD, which needs an objective optical system having a NA of 0.85 to record and/or reproduce information for the optical disk and the thickness of the protective substrate of the optical disk is substantially equal to 0.1 mm; and an optical disk, for example HD, which needs an objective optical system having NA of 0.65-0.67 to record and/or reproduce information for the optical disk and the thickness of the protective layer of the optical disk is substantially equal to 0.6 mm. In addition to optical discs having these protective layers on their recording surfaces, the high density optical disk also includes an optical disk having a protective substrate with a thickness of several nm to several tens nm, and an optical disk having no protective substrate or no protective substrate on the recording surface. In this specification, the high density optical disk includes an optical-magnetic disk which requires a blue-violet semiconductor laser diode or a blue-violet SHG laser for recording and/or reproducing information for the high density optical disk as a light source.

In the present specification, optical discs in DVD series such as DVD-ROM, DVD-Video, DVD-Audio, DVD-RAM, DVD-R, DVD-RW, DVD+R and DVD+RW are called “DVD” generically, and optical discs in CD series such as CD-ROM, CD-Audio, CD-Video, CD-R and CD-RW are called “CD” generically.

The optical pickup apparatus according to the present invention conducts reproducing and/or recording information for the first optical information recording medium having the protective layer with the thickness of t1, and the optical pickup apparatus conducts reproducing and/or recording information for the second optical information recording medium with the thickness of t2 (t2>t1), using the first light flux with the wavelength λ1 emitted by the first light source. Therefore, the structure can seek to be simplified and to provide low cost by commonly using the first light source and the incidence optical system. In this case, the liquid crystal correcting element can properly correct the spherical aberration caused due to the thicknesses of the protective layers of the first optical information recording medium and the second optical information recording medium. Further, the optical element in the incidence optical system is fixed in at least the direction of the optical axis. Therefore, an actuator for driving in the direction of the optical axis is not required. It allows to provide a simple optical pickup apparatus.

Item 2 provides the optical pickup apparatus according to the structure of Item 1, further including a holder for holding the first objective optical system and the second objective optical system. The incidence optical system including a coupling lens where the first light flux to the third light flux commonly pass through. The holder is driven so that one of the first objective optical system and the second objective optical system receives a light flux having passed through the coupling lens. Therefore, it allows to compatibly conduct recording and/or reproducing information by mechanically switching the first objective optical system and the second objective optical system. And it allows to seek to simplify the incidence optical system by providing a single incidence optical system.

In this case, the objective lens and the liquid crystal correcting element which form the first objective optical system preferably moves as one body. In other words, when the objective lens moves, the liquid crystal correcting element preferably moves, too.

Item 3 provides the optical pickup apparatus according to the structure of claim 1 or 2, in which the incidence optical system includes: a first coupling lens for transmitting a light flux to enter into the first objective optical system; and a second coupling lens for transmitting a light flux to enter into the second objective optical system. In the optical pickup apparatus, the light flux to enter into the first objective optical system travels a different optical path from the light flux to enter into the second objective optical system. Therefore, it allows to compatibly conduct recording and/or reproducing information without using a mechanism mechanically switching the first objective optical system and the second objective optical system. It further allows to provide a simpler optical pickup apparatus.

Item 4 provides an optical pickup apparatus including: a first light source for emitting a first light flux having a wavelength λ1; a second light source for emitting a second light flux having a wavelength λ2 (λ2>λ1); a third light source for emitting a third light flux having a wavelength λ3 (λ3>λ2); a first objective optical system; a second objective optical system; an incidence optical system for emitting the first to third light fluxes into one of the first objective optical system and the second objective optical system; and an optical detector. In the optical pickup apparatus, the first objective optical system is adopted to converge the first light flux with the wavelength λ1 emitted by the first light source onto an information recording surface of a first optical information recording medium having a first protective layer whose thickness is t1 so that the optical pickup apparatus conducts reproducing and/or recording information for the first optical information recording medium. The first objective optical system is further adopted to converge the first light flux onto an information recording surface of a second optical information recording medium having a second protective layer whose thickness is t2 (t2>t1) so that the optical pickup apparatus conducts reproducing and/or recording information for the second optical information recording medium. In the optical pickup apparatus, the second objective optical system is adopted to converge the second light flux with the wavelength λ2 emitted by the second light source onto an information recording surface of the third optical information recording medium having a third protective layer whose thickness is t3 (t3>t1) so that the optical pickup apparatus conducts reproducing and/or recording information for the third optical information recording medium. The second objective optical system is further adopted to converge the third light flux with the wavelength λ3 emitted by the third light flux onto an information recording surface of the fourth optical information recording medium having a fourth protective layer whose thickness is t4 (t4>t3) so that the optical pickup apparatus conducts reproducing and/or recording information for the fourth optical information recording medium. The first objective optical system includes an objective lens and a liquid crystal correction element. The liquid crystal correction element is adopted to correct an amount of spherical aberration of the light flux passing through the liquid crystal correction element. The incidence optical system includes a coupling lens which is movable along an optical axis and transmits a light flux prior to being collimated.

In the structure, the light flux entering into the first objective optical system always passes through the objective lens and the liquid crystal correcting element which form the first objective optical system.

The objective lens forming the first objective optical system is preferably a single lens.

The optical pickup apparatus according to the present invention conducts reproducing and/or recording information for the first optical information recording medium having the protective layer with the thickness of t1, and the optical pickup apparatus conducts reproducing and/or recording information for the second optical information recording medium with the thickness of t2 (t2>t1), using the first light flux with the wavelength λ1 emitted by the first light source. Therefore, the structure can seek to be simplified and to provide low cost by commonly using the first light source and the incidence optical system. In this case, the liquid crystal correcting element can properly correct the spherical aberration caused due to the thicknesses of the protective layers of the first optical information recording medium and the second optical information recording medium. However, when the first optical information recording medium and/or the second optical information recording medium has plural layers of information recording surfaces, the liquid crystal correcting element sometimes does not provide a sufficient amount of a spherical aberration correction required to conduct recording and/or reproducing information properly for each of the layers. To solve that, in the case that the amount a spherical aberration correction of the liquid crystal correcting element is insufficient, the structure drives the coupling lens along the optical axis to correct the spherical aberration properly as the total system and to conduct recording and/or reproducing information properly for the plural layers of the information recording surfaces, even when the first optical information recording medium and/or the second optical information recording medium has plural layers of information recording surfaces. However, the coupling lens is driven along the optical axis to correct the spherical aberration not only when the optical pickup apparatus conducts recording and/or reproducing information for the plural layers of information recording surfaces.

Item 5 provides the optical pickup apparatus according to the structure of Item 4, in which the objective lens and the liquid crystal correction element, in the first objective optical system, are integrally formed as one body.

Item 6 provides the optical pickup apparatus according to the structure of Item 4 or 5, in which the incidence optical system includes: a first coupling lens for transmitting a light flux to enter into the first objective optical system and a second coupling lens for transmitting a light flux to enter into the second objective optical system. In the optical pickup apparatus, the light flux to enter into the first objective optical system travels a different optical path from the light flux to enter into the second objective optical system. Therefore, it allows to compatibly conduct recording and/or reproducing information without using a mechanism mechanically switching the first objective optical system and the second objective optical system. It further allows to provide a further simpler optical pickup apparatus.

Item 7 provides the optical pickup apparatus according to the structure of Item 6, further including a common actuator for driving the first coupling lens and the second coupling lens along the optical axis.

Item 8 provides the optical pickup apparatus according to the structure of Item 6, further including: an actuator for driving the first coupling lens along the optical axis; and an actuator for driving the second coupling lens along the optical axis.

Item 9 provides the optical pickup apparatus according to the structure of any one of Items 4 to 8, in which an amount of a spherical aberration corrected by the liquid crystal correction element is smaller than an amount of a spherical aberration corrected by driving the coupling lens along the optical axis.

Item 10 provides the optical pickup apparatus according to the structure of any one of Items 4 to 8, in which an amount of a spherical aberration corrected by the liquid crystal correction element is larger than an amount of a spherical aberration corrected by driving the coupling lens along the optical axis.

Item 11 provides the optical pickup apparatus according to the structure of any one of Items 4 to 10, in which the objective lens in the first objective optical system has a numerical aperture NA of 0.6 or more. In the optical pickup apparatus, both when the first light flux is converged on the information recording surface through the first protective layer and when the first light flux is converged on the information recording surface through the second protective layer, an amount ΔSA of a spherical aberration corrected by driving the coupling lens along the optical axis, satisfies a following conditional expression (1) within the numerical aperture NA of 0.6:

0.8<|ΔSA(WFEλrms)|<1.6. (1)

Therefore, it allows to properly conduct recording and/or reproducing information for each of the BD and HD DVD.

When the value of the expression (1) becomes lower than the lower limit of the expression (1), it increases recording errors and reproducing errors because of an insufficient amount of the spherical aberration correction. Further, when the value of the expression (1) becomes larger than the upper limit of the expression (1), it increases recording errors and reproducing errors because of the excessive amount of the spherical aberration correction.

In the above structure, it is preferable that the objective lens in the first objective optical system has a numerical aperture of 0.65 or more and ΔSA satisfies the expression (1) within the numerical aperture of 0.65. It allows to properly conduct recording and/or reproducing information for the high density optical disk.

Item 12 provides the optical pickup apparatus according to the structure of any one of Items 1 to 11, in which the optical detector is a common detector which receives and detects each of the first light flux, the second light flux, and the third light flux. Therefore, it provides further simpler optical pickup apparatus by using a single optical detector.

In this specification, a “common optical detector” means the situation that the optical detector can receive and detect all of the light fluxes with different wavelengths by using a single light-receiving element or a plural light-receiving elements in the optical detector. For example, even when the optical detector includes light-receiving elements for respective light fluxes with different wavelengths, the light-receiving elements which are included in one housing or which are mounted on one plane, may be represented as a common optical detector.

Item 13 provides the optical pickup apparatus according to the structure of any one of Items 1 to 12, which satisfies the following expression.

t3>=t2

Item 14 provides the optical pickup apparatus according to the structure of any one of Items 1 to 13, in which the objective lens of the first objective optical system has a numerical aperture of 0.6 or more.

Item 15 provides the optical pickup apparatus according to the structure of any one of Items 1 to 14, in which the objective lens in the first objective optical system has a numerical aperture NA of 0.6 or more. In the optical pickup apparatus, both when the first light flux is converged on the information recording surface through the first protective layer and when the first light flux is converged on the information recording surface through the second protective layer, an amount ΔSA of a spherical aberration corrected by the liquid crystal correction element, satisfies a following conditional expression within the numerical aperture NA of 0.6:

0.8<|ΔSA(WFEλrms)|<1.6. (2)

Therefore, it allows to conduct recording and/or reproducing information properly for each of BD and HD DVD.

When the value of the expression (2) becomes lower than the lower limit of the expression (2), it increases recording errors and reproducing errors because of an insufficient amount of the spherical aberration correction. Further, when the value of the expression (2) becomes larger than the upper limit of the expression (2), it increases recording errors and reproducing errors because of the excessive amount of the spherical aberration correction.

In the above structure, it is preferable that the objective lens in the first objective optical system has a numerical aperture of 0.65 or more and ΔSA satisfies the expression (1) within the numerical aperture of 0.65. It allows to properly conduct recording and/or reproducing information for the high density optical disk.

Item 16 provides the optical pickup apparatus according to the structure of any one of Items 1 to 15, in which the incidence optical system comprises: a common coupling lens for transmitting the first to third light fluxes; and a wavelength selective element for transmitting or reflecting each of the first to third light fluxes having passed through the common coupling lens, depending on a wavelength of the each of the first to third light fluxes. Therefore, it provides the further simplified optical pickup apparatus.

Item 17 provides the optical pickup apparatus according to the structure of any one of Items 1 to 16, in which a light flux to enter into the first objective optical system travels a different optical path from a light flux to enter into the second objective optical system. Therefore, it allows to compatibly conduct recording and/or reproducing information with providing the common coupling lens, for example without using the mechanism mechanically switching the first objective optical system and the second objective optical system. It allows to provide a further simplified optical pickup apparatus.

Item 18 provides the optical pickup apparatus according to the structure of any one of Items 1 to 17, in which the first objective optical system is adopted to converge the first light flux onto an information recording surface of the first optical information recording medium and an information recording surface of the second optical information recording medium. In the pickup apparatus, the liquid crystal correcting element corrects the spherical aberration whose amount differs between when the first objective optical system converges the first light flux onto an information recording surface of the first optical information recording medium and when the first objective optical system converges the first light flux onto an information recording surface of the second optical information recording medium. Therefore, it allows to compatibly conduct recording and/or reproducing information with maintaining a higher light utilization efficiency. It allows to provide a further simplified optical pickup apparatus.

Item 19 provides the optical pickup apparatus according to the structure of any one of Items 1 to 18, in which the second objective optical system is adopted to converge the second light flux onto an information recording surface of the third optical information recording medium and to converge the third light flux onto an information recording surface of the fourth optical information recording medium. Therefore, it allows to provide a low-cost optical pickup apparatus using a compatible objective lens for DVD and CD, which has already been developed and which is low in cost.

Item 20 provides the optical pickup apparatus according to the structure of any one of Items 1 to 19, in which the objective lens of the first objective optical system is configured to satisfy Δ1>Δ5 and Δ2>Δ5. Where, Δ1 is an amount of a spherical aberration caused when the first objective optical system converges the first light flux onto the information recording surface through the first protective layer, Δ2 is an amount of a spherical aberration caused when the first objective optical system converges the first light flux onto the information recording surface through the second protective layer, and Δ5 is an amount of a spherical aberration caused when the first objective optical system converges the first light flux onto an information recording surface through a protective layer with a thickness t5 (t2>t5>t1).

Item 21 provides the optical pickup apparatus according to any one of Items 1 to 19, in which the objective lens of the first objective optical system is configured to satisfy Δ1<Δ5<Δ2. Where Δ1 is an amount of a spherical aberration caused when the first objective optical system converges the first light flux onto the information recording surface through the first protective layer, Δ2 is an amount of a spherical aberration caused when the first objective optical system converges the first light flux onto the information recording surface through the second protective layer, and Δ5 is an amount of a spherical aberration caused when the first objective optical system converges the first light flux onto an information recording surface through a protective layer with a thickness t5 (t2>t5>t1).

Item 22 provides the optical pickup apparatus according to any one of Items 2 to 21, in which the incidence optical system includes a coupling lens, and the coupling lens includes an optical surface with a phase structure.

In the present specification, the phase structure is a generic term referring to a structure, having steps in the direction of optical axis, for providing an optical path difference (phase difference) to the incoming light flux. The optical path difference provided by these steps can be integer times as large as the wavelength of the incoming light flux or a non-integer times as large as the wavelength of the incoming light flux. Specific examples of such a phase structure include a diffractive structure with the aforementioned step arranged at periodic intervals in the direction of optical axis, and an optical path difference providing structure (also called a phase difference providing structure) with the aforementioned step arranged at aperiodic intervals in the direction of optical axis.

As the diffractive structure, there is the following structures: the structure (diffractive structure DOE), as typically shown in FIG. 9, which is structured by a plurality of ring-shaped zones 100 and whose sectional shape including the optical axis is the serrated shape; the structure (diffractive structure DOE), as typically shown in FIG. 10, which is structured by a plurality of ring-shaped zones 102 whose steps 101 extend in the same direction within the effective aperture, and whose sectional shape including the optical axis is the stepped shape; the structure (diffractive structure DOE), as typically shown in FIG. 11, which is structured by a plurality of ring-shaped zones 105 in which extending direction of steps 104 switches on the mid-way of the effective diameter, and in which the cross sectional shape of the structure including the optical axis is the stepped shape; the structure (diffractive structure HOE), as typically shown in FIG. 12, which is structured by a plurality of ring-shaped zones 103 each including therein the step structure. Further, as the optical path difference providing structure, there is the following structures: the structure (NPS), as typically shown in FIG. 11, which is structured by a plurality of ring-shaped zones 105 in which extending direction of steps 104 switch on the mid-way of the effective diameter and in which the cross sectional shape of the structure including the optical axis is the stepped shape. Hereupon, FIG. 9 to FIG. 12 typically show structures each including the phase structure formed on a plane, however, each phase structure may also be formed on a spherical surface or an aspherical surface. Further, any one of the diffractive structure or the optical path difference providing structure may sometimes provide the structure shown in FIG. 11.

Item 23 provides the optical pickup apparatus according to the structure of any one of Items 2 to 21, in which the incidence optical system includes a coupling lens, and each optical surface of the coupling lens consists of a refractive surface. Therefore, it allows to provide an optical element which is easily manufactured.

Item 24 provides the optical pickup apparatus according to the structure of any one of Items 1 to 23, in which the first to third light sources are housed in a common package.

Item 25 provides the optical pickup apparatus according to the structure of any one of any one of Items 1 to 24, in which the second and third light sources are housed in a common package.

Item 26 provides the optical pickup apparatus according to the structure of any one of Items 1 to 25, in which at least one optical element in the first objective optical system and the second objective optical system comprises a plastic resin in which inorganic microparticles with a diameter of 30 nm or less are dispersed. The at least one of the first objective optical system and the second objective optical system, has an amount |dn/dT| of a change in a refractive index with a temperature change of less than 8×10⁻⁵.

Inorganic microparticles to be dispersed in thermoplastic resin, which an example of the plastic resin, are not limited in particular, and suitable microparticles can be arbitrarily selected from inorganic microparticles whose ratio (hereinafter, |dn/dT|) of change in refractive index with the temperature is small, which enables to achieve an object of the present invention. To be concrete, oxide microparticles, metal salt microparticles and semiconductor microparticles are preferably used, and it is preferable to use by selecting properly those in which absorption, light emission and fluorescence are not generated in the wavelength range employed for an optical element, from the aforesaid microparticles.

The following metal oxide is used for oxide microparticles used in the present invention: a metal oxide constructed by one or more kinds of metal selected by a group including Li, Na, Mg, Al, Si, K, Ca, Sc, Ti, V, Cr, Mn, Fe, Co, Ni, Cu, Zn, Rb, Sr, Y, Nb, Zr, Mo, Ag, Cd, In, Sn, Sb, Cs, Ba, La, Ta, Hf, W, Ir, Tl, Pb, Bi and rare earth metal. More specifically, for example, oxide such as silicon oxide, titanium oxide, zinc oxide, aluminum oxide, zirconium oxide, hafnium oxide, niobium oxide, tantalum oxide, magnesium oxide, calcium oxide, strontium oxide, barium oxide, indium oxide, tin oxide, lead oxide; complex oxide compounds these oxides such as lithium niobate, potassium niobate and lithium tantalate, the aluminum magnesium oxide (MgAl₂O₄) are cited. Furthermore, rare earth oxides are used for the oxide microparticles in the structure according to the present invention. More specifically, for example, scandium oxide, yttrium oxide, lanthanum trioxide, cerium oxide, praseodymium oxide, neodymium oxide, samarium oxide, europium oxide, gadolinium oxide, terbium oxide, dysprosium oxide, holmium oxide, erbium oxide, thulium oxide, ytterbium oxide, lutetium oxide are cited. As metal salt microparticles, the carbonate, phosphate, sulfate, etc. are cited. More specifically, for example, calcium carbonate, aluminum phosphate are cited.

Moreover, semiconductor microparticles in the present invention mean the microparticles constructed by a semiconducting crystal. The semiconducting crystal composition examples include simple substances of the 14th group elements in the periodic table such as carbon, silica, germanium and tin; simple substances of the 15th group elements in the periodic table such as phosphor (black phosphor); simple substances of the 16th group elements in the periodic table such as selenium and tellurium; compounds comprising a plural number of the 14th group elements in the periodic table such as silicon carbide (SiC); compounds of an element of the 14th group in the periodic table and an element of the 16th group in the periodic table such as tin oxide (IV) (SnO₂), tin sulfide (II, IV) (Sn(II)Sn(IV)S₃), tin sulfide (IV) (SnS₂), tin sulfide (II) (SnS), tin selenide (II) (SnSe), tin telluride (II) (SnTe), lead sulfide (II) (PbS), lead selenide (II) (PbSe) and lead telluride (II) (PbTe); compounds of an element of the 13th group in the periodic table and an element of the 15th group in the periodic table (or III-V group compound semiconductors) such as boron nitride (BN), boron phosphide (BP), boron arsenide (BAs), aluminum nitride (AlN), aluminum phosphide (AlP), aluminum arsenide (AlAs), aluminum antimonide (AlSb), gallium nitride (GaN), gallium phosphide (GaP), gallium arsenide (GaAs), gallium antimonide (GaSb), indium nitride (InN), indium phosphide (InP), indium arsenide (InAs) and indium antimonide (InSb); compounds of an element of the 13th group in the periodic table and an element of the 16th group in the periodic table such as aluminum sulfide (Al₂S₃), aluminum selenide (Al₂Se₃), gallium sulfide (Ga₂S₃), gallium selenide (Ga₂Se₃), gallium telluride (Ga₂Te₃), indium oxide (In₂O₃), indium sulfide (In₂S₃), indium selenide (In₂Se₃) and indium telluride (In₂Te₃); compounds of an element of the 13th group in the periodic table and an element of the 16th group in the periodic table such as thallium chloride (I) (TlCl), thallium bromide (I) (TlBr), thallium iodide (I) (TlI); compounds of an element of the 12th group in the periodic table and an element of the 16th group in the periodic table (or II-V1 group compound semiconductors) such as zinc oxide (ZnO), zinc sulfide (ZnS), zinc selenide (ZnSe), zinc telluride (ZnTe), cadmium oxide (CdO), cadmium sulfide (CdS), cadmium selenide (CdSe), cadmium telluride (CdTe), mercury sulfide (HgS), mercury selenide (HgSe) and mercury telluride (HgTe); compounds of an element of the 15th group in the periodic table and an element of the 16th group in the periodic table such as arsenic sulfide (III) (As₂S₃), arsenic selenide (III) (As₂Se₃), arsenic telluride (III) (As₂Te₃), antimony sulfide (III) (Sb₂S₃), antimony selenide (III) (Sb₂Se₃), antimony telluride (III) (Sb₂Te₃), bismuth sulfide (III) (Bi₂S₃), bismuth selenide (III) (Bi₂Se₃) and bismuth telluride (III) (Bi₂Te₃); compounds of an element of the 11th group in the periodic table and an element of the 16th group in the periodic table such as copper oxide (I) (Cu₂O) and copper selenide (I) (Cu₂Se); compounds of an element of the 11th group in the periodic table and an element of the 17th group in the periodic table such as copper chloride (I) (CuCl), copper bromide (I) (CuBr), copper iodide (I) (CuI), silver chloride (AgCl) and silver bromide (AgBr); compounds of an element of the 10th group in the periodic table and an element of the 16th group in the periodic table such as nickel oxide (II) (NiO); compounds of an element of the 9th group in the periodic table and an element of the 16th group in the periodic table such as cobalt oxide (II) (CoO) and cobalt sulfide (II) (CoS); compounds of an element of the 8th group in the periodic table and an element of the 16th group in the periodic table such as triiron tetraoxide (Fe₃O₄) and iron sulfide (II) (FeS); compounds of an element of the 7th group in the periodic table and an element of the 16th group in the periodic table such as manganese oxide (II) (MnO); compounds of an element of the 6th group in the periodic table and an element of the 16th group in the periodic table such as molybdenum sulfide (IV) (MoS₂) and tungsten oxide(IV) (WO₂); compounds of an element of the 5th group in the periodic table and an element of the 16th group in the periodic table such as vanadium oxide (II) (VO), vanadium oxide (IV) (VO₂) and tantalum oxide (V) (Ta₂O₅); compounds of an element of the 4th group in the periodic table and an element of the 16th group in the periodic table such as titanium oxide (such as TiO₂, Ti₂O₅, Ti₂O₃ and Ti₅O₉); compounds of an element of the 2th group in the periodic table and an element of the 16th group in the periodic table such as magnesium sulfide (MgS) and magnesium selenide (MgSe); chalcogen spinels such as cadmium oxide (II) chromium (III) (CdCr₂O₄), cadmium selenide (II) chromium (III) (CdCr₂Se₄), copper sulfide (II) chromium (III) (CuCr₂S₄) and mercury selenide (II) chromium (III) (HgCr₂Se₄); and barium titanate (BaTiO₃). Further, semiconductor clusters structures of which are established such as BN75(BF2)15F15, described in Adv. Mater., vol. 4, p. 494 (1991) by G. Schmid, et al.; and Cu₁₄₆Se₇₃(triethylphosphine)₂₂ described in Angew. Chem. Int. Ed. Engl., vol. 29, p. 1452 (1990) by D. Fenske are also listed as examples.

In general, dn/dT of thermoplastic resin has a negative value, namely, a refractive index becomes smaller as the temperature rises. Therefore, it is preferable to disperse microparticles having large dn/dT, in order to make |dn/dT| of thermoplastic resin composition to be efficiently small. It is preferable that the absolute value of dn/dT of the microparticles is smaller than that of the thermoplastic resin used as a base material when using microparticles having dn/dT with same sign to the sign of dn/dT of the thermoplastic resin. Furthermore, microparticles having positive dn/dT, which is microparticles having different sign of dn/dT from that of the thermoplastic resin which is a base material, are preferably used. By dispersing these kinds of microparticles into the thermoplastic resin, |dn/dT| of thermoplastic resin composition can effectively become small with less amount of the microparticles. It is possible to properly select dn/dT of microparticles to be dispersed corresponding to a value of dn/dT of thermoplastic resin to become a base material. However, it is preferable that dn/dT of microparticles is greater than −20×10⁻⁶ and it is more preferable that dn/dT of microparticles is greater than −10×10⁻⁶ when microparticles are dispersed into a thermoplastic resin which is preferably employed to a general optical element. As microparticles having large dn/dT, gallium nitride, zinc sulfate, zinc oxide, lithium niobate and lithium tantalite, for example, are preferably used.

On the other hand, when dispersing microparticles in thermoplastic resin, it is preferable that a difference of refractive index between the thermoplastic resin to become a base material and the microparticles is small. Scattering is hardly caused when light is transmitted, if a difference of refractive index between the thermoplastic resin and the microparticles to be dispersed is small. In case of dispersing microparticles in the thermoplastic resin, microparticles in larger size easily cause scattering when light flux transmits the material. However, in a material in which a difference of refractive index between the thermoplastic resin and the microparticles to be dispersed is small, an occurrence of light scattering becomes low even when relatively large-sized microparticles are used. A difference of refractive index between the thermoplastic resin and the microparticles to be dispersed is preferably within the range of 0-0.3, and more preferably within the range of 0-0.15.

Refractive indexes of thermoplastic resins preferably used as optical materials are in the range about 1.4 to 1.6 in many cases. As materials to be dispersed in these thermoplastic resins, silica (silicon oxide), calcium carbonate, aluminum phosphate, aluminum oxide, magnesium oxide, and aluminum.magnesium oxides, for example, are preferably used.

Further, studies made by the inventors have clarified that dn/dT of thermoplastic resin composition can be made small effectively, by dispersing microparticles whose refractive index is relatively low. As a reason why |dn/dT| of thermoplastic resin composition including dispersed microparticles with low refractive index becomes small, it is considered that temperature changes of the volume fraction of inorganic microparticles in the resin composition may work to make the |dn/dT| of the resin composition to become smaller when the refractive index of the microparticles is lower, although the details are not clarified. As microparticles having a relatively low refractive index, silica (silicon oxide), calcium carbonate and aluminum phosphate, for example, are preferably used.

It is difficult to simultaneously achieve all of improving an effect of lowering dn/dT of the thermoplastic resin composition, improving of light transmittance and a desired refractive index. Therefore, microparticles to be dispersed in the thermoplastic resin can be selected properly by considering a magnitude of dn/dT of a microparticle itself, a difference of dn/dT between microparticles and the thermoplastic resin to become a base material, and the refractive index of the microparticles, depending on the characteristics which are required for the thermoplastic resin composition. Further, it is preferable, for maintaining light transmittance, to properly select microparticles which hardly cause light scattering with considering its affinity with the thermoplastic resin to become a base material, namely, characteristics of the microparticles in dispersion for the thermoplastic resin.

For example, when using cyclic olefin polymer preferably employed for an optical element as a base material, silica is preferably used as microparticles which make |dn/dT| small while keeping light transmittance.

For the microparticles mentioned above, it is possible to use either one type of inorganic microparticles or plural types of inorganic microparticles in combination. By using plural types of microparticles each having a different characteristic, the required characteristics can further be improved efficiently.

Inorganic microparticles relating to the present invention preferably has an average particle size being 1 nm or larger and being 30 nm or smaller and more preferably has an average particle size being 1 nm or more and being 10 nm or less. When the average particle size is less than 1 nm, dispersion of the inorganic microparticles is difficult, resulting in a fear that the required efficiency may not be obtained, therefore, it is preferable that the average particle size is 1 nm or more. When the average particle size exceeds 30 nm, thermoplastic material composition obtained becomes muddy and transparency is lowered, resulting in a fear that the light transmittance may become less than 70%, therefore, it is preferable that the average particle size is 30 nm or less. The average particle size mentioned here means volume average value of a diameter (particle size in conversion to sphere) in conversion from each particle into a sphere having the same volume as that of the particle.

Further, a form of an inorganic microparticle is not limited in particular, but a spherical microparticle is used preferably. To be concrete, a range of 0.5-1.0 for the ratio of the minimum size of the particle (minimum value of the distance between opposing two tangents each touching the outer circumference of the microparticle)/the maximum size (maximum value of the distance between opposing two tangents each touching the outer circumference of the microparticle) is preferable, and a range of 0.7-1.0 is more preferable.

A distribution of particle sizes is not limited in particular, but a relatively narrow distribution is used suitably, rather than a broad distribution, for making the invention to exhibit its effect efficiently.

Item 27 provides the optical pickup apparatus according to the structure of any one of Items 1 to 26, in which at least one of the first objective optical system and the second objective optical system comprises a glass, and has an amount |dn/dT| of a change in a refractive index with a temperature change of less than 5×10⁻⁵. Therefore, it provides an objective optical element so as to control the change in spherical aberration even when the temperature distribution changes.

Item 28 provides an optical information recording and/or reproducing apparatus for an optical information medium, including an optical pickup apparatus. The optical pickup apparatus includes: a first light source for emitting a first light flux having a wavelength λ1; a second light source for emitting a second light flux having a wavelength λ2 (λ2>λ1); a third light source for emitting a third light flux having a wavelength λ3 (λ3>λ2); a first objective optical system; a second objective optical system; an incidence optical system for emitting the first to third light fluxes into one of the first objective optical system and the second objective optical system; and an optical detector. The first objective optical system is adopted to converge the first light flux with the wavelength λ1 emitted by the first light source onto an information recording surface of a first optical information recording medium having a first protective layer whose thickness is t1 so that the optical pickup apparatus conducts reproducing and/or recording information for the first optical information recording medium. The first objective optical system is adopted to converge the first light flux onto an information recording surface of a second optical information recording medium having a second protective layer whose thickness is t2 (t2>t1) so that the optical pickup apparatus conducts reproducing and/or recording information for the second optical information recording medium. The second objective optical system is adopted to converge the second light flux with the wavelength λ2 emitted by the second light source onto an information recording surface of a third optical information recording medium having a third protective layer whose thickness is t3 (t3>t1) so that the optical pickup apparatus conducts reproducing and/or recording information for the third optical information recording medium. The second objective optical system is adopted to converge the third light flux with the wavelength λ3 emitted by the third light flux onto an information recording surface of a fourth optical information recording medium having a fourth protective layer whose thickness is t4 (t4>t3) so that the optical pickup apparatus conducts reproducing and/or recording information for the fourth optical information recording medium. The first objective optical system comprises an objective lens, and a liquid crystal correction element being adopted to correct an amount of spherical aberration of the light flux passing through the liquid crystal correction element. The incidence optical system includes an optical element arranged statically along at least an optical axis.

Item 29 provides an optical information recording and/or reproducing apparatus for an optical information medium, comprising an optical pickup apparatus. The optical pickup apparatus includes: a first light source for emitting a first light flux having a wavelength λ1; a second light source for emitting a second light flux having a wavelength λ2 (λ2>λ1); a third light source for emitting a third light flux having a wavelength λ3 (λ3>λ2); a first objective optical system; a second objective optical system; an incidence optical system for emitting the first to third light fluxes into one the first objective optical system and the second objective optical system; and an optical detector. The first objective optical system is adopted to converge the first light flux with the wavelength λ1 emitted by the first light source onto an information recording surface of a first optical information recording medium having a first protective layer whose thickness is t1 so that the optical pickup apparatus conducts reproducing and/or recording information for the first optical information recording medium. The first objective optical system is adopted to converge the first light flux onto an information recording surface of a second optical information recording medium having a second protective layer whose thickness is t2 (t2>t1) so that the optical pickup apparatus conducts reproducing and/or recording information for the second optical information recording medium. The second objective optical system is adopted to converge the second light flux with the wavelength λ2 emitted by the second light source onto an information recording surface of a third optical information recording medium having a third protective layer whose thickness is t3 (t3>t1) so that the optical pickup apparatus conducts reproducing and/or recording information for the third optical information recording medium. The second objective optical system is adopted to converge the third light flux with the wavelength λ3 emitted by the third light flux onto an information recording surface of a fourth optical information recording medium having a fourth protective layer whose thickness is t4 (t4>t3) so that the optical pickup apparatus conducts reproducing and/or recording information for the fourth optical information recording medium. The first objective optical system comprises an objective lens, and a liquid crystal correction element being adopted to correct an amount of spherical aberration of the light flux passing through the liquid crystal correction element. The incidence optical system includes a coupling lens which is movable along an optical axis and transmits a light flux prior to being collimated.

In this specification, an objective lens denotes a lens having a converging function, the objective lens being placed at the position, which is the closest position to the optical information recording medium and being opposed to the optical information recording medium in the status where the optical information recording medium is installed in the optical pickup apparatus in a narrow sense. In a broad sense, the objective lens denotes a lens, which is capable of being moved in the optical axis direction by an actuator together with the prescribed lens. Accordingly, in this specification, a numerical aperture NA of the objective lens in an optical information recording medium side (or an image side) denotes a numerical aperture of the surface positioned at the closest place to the optical information recording medium in the objective lens. Further, in this specification, a required numerical aperture denotes a numerical aperture of the diffraction-limited objective lens, which is capable of obtaining a required spot diameter to conduct recording and/or reproducing operation corresponding to the wavelength of the light flux of the light source to be used.

According to the structure described above, it is possible to provide an optical pickup apparatus including the objective lens, which is capable of appropriately conducting recording and/or reproducing information for four different standards of optical discs, even though the optical pickup apparatus is simple and compact.

### EXAMPLES

### First Embodiment

The present invention will be further described in detail by referring to drawings hereinafter. In the embodiment, which will be described later, the recording densities (ρ1 through ρ4) of from the first optical disk OD1 to the fourth optical disk OD4 are set as ρ4<ρ3<ρ2<ρ1.

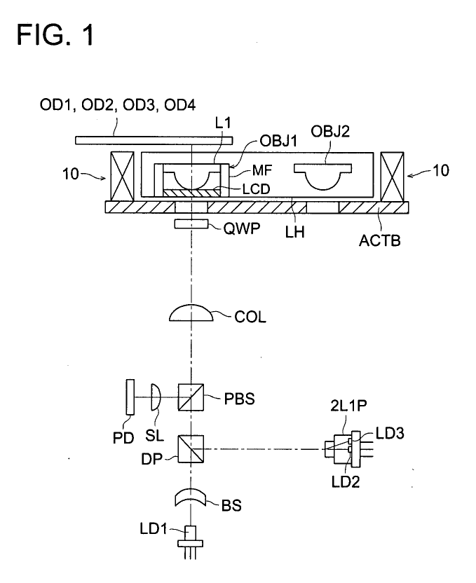

FIG. 1 illustrates a schematic cross sectional view for the optical pickup apparatus of the first embodiment of the present invention, which is capable of recording and/or reproducing information for all types of discs such as a high density optical disk (the first optical disk OD1 or the second optical disk OD2), conventional DVD (the third optical disk) and CD (the fourth optical disk OD4).

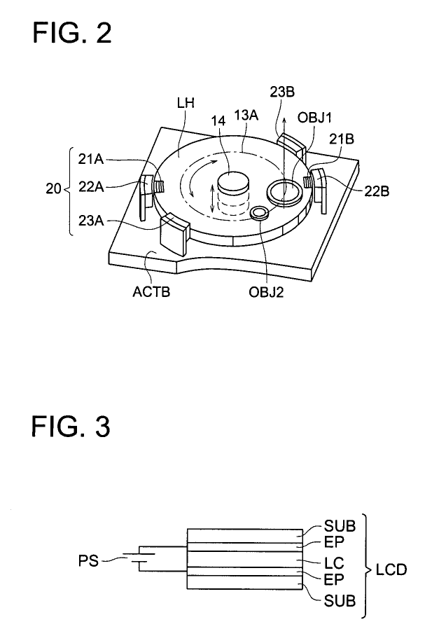

FIG. 2 illustrates a perspective view of the objective lens actuator apparatus used for the optical pickup apparatus of the embodiment. Firstly, the objective lens actuator apparatus will be described. The objective lens actuator mechanism (it will be called a driving device) 10 shown in FIG. 2 is arranged in the optical pickup apparatus shown in FIG. 1. The objective lens actuator mechanism 10 includes objective optical systems OBJ1 (it will be called a first objective optical system) and OBJ2 (the second objective optical system) each for converging laser light flux from a semiconductor laser, which will be described later, onto the respective information recording surfaces of the different optical discs; a lens holder LH, which is a holding member, for holding the optical axes of these objective optical systems OBJ1 and OBJ2 on the same circumference 13A; an actuator base ACTB for holding this lens holder LH so that the lens holder LH freely rotates around a support shaft 14 provided on a center axis of the circumference 13A and reciprocally and freely moves along the center shaft of this rotation; a focusing actuator (not shown) for reciprocally moving the lens holder LH along the support shaft 14; and a tracking actuator 20 for fixing the positions of respective objective lenses OBJ1 and OBJ2 by giving rotational force to the lens holder LH. Operation control circuit (not shown) for conducting operation control of respective actuators is provided in this objective lens actuator mechanism 10.

The objective optical systems OBJ1 and OBJ2 are respectively provided in the hole-sections passing through the flat plate of the disk-shaped lens holder LH. The objective optical systems OBJ1 and OBJ2 are provided at the positions, which are positioned at the equal distance from the center of the lens holder LH. This lens holder LH connects to the upper edge section of the support shaft 14 standing on the actuator base ACTB at the center of the lens holder LH so as to freely rotate around the center shaft. A focusing actuator (not shown) is provided beneath this support shaft 14.

Namely, this focusing actuator configures an electromagnetic solenoid with a coil which is provided around a permanent magnet provided under the support shaft 14. The focusing actuator is adopted to adjust the focal length by giving force to the support shaft 14 and the lens holder LH to reciprocally move them in a microscopic unit in the direction along the support shaft 14 (up and down direction in FIG. 2) based on the adjustment of the electrical current in the coil.

Further, as described above, the tracking actuator 20, which is a driving mechanism, gives this lens holder LH the first swing operation and the second swing operation centering on the support shaft 14 having an axis line, which is parallel to the optical axis. This tracking actuator 20 comprises: a pair of tracking coils 21A and 21B, which are provided on the edge section of the lens holder LH with sandwiching the support shaft 14 so as to be symmetric with respect to the support shaft 14; and two pair of magnets 22A and 22B, and 23A and 23B, which are provided close to the edge section of the lens holder LH with sandwiching the support shaft provided on the actuator base ACTB so as to be symmetric with respect to the support shaft 14.

The positions of the magnets 22A and 22B are set so that when the tracking coils 21A and 21B oppose to the pair of magnets 22A and 22B, the objective optical system OBJ1 positions above the optical path of laser light flux. The positions of the magnets 23A and 23B are set so that when the tracking coils 22A and 22B oppose to the pair of magnets 23A and 23B, the objective optical system OBJ2 positions above the optical path of laser light flux.

A stopper (not shown) for limiting the swing range of the lens holder LH is provided on the lens holder LH so that the tracking coil 21A does not oppose to the magnet 22B or 23B and the tracking coil 21B does not oppose to the magnet 22A or 23A.

Further, the tracking actuator 20 is disposed so that the tangential line direction of the circumference of the circular shaped lens holder LH is perpendicular to the tangential line direction of the track on the optical disk. The tracking actuator 20 is provided to correct the tracking error of the irradiating position against the track on the optical disk by giving this lens holder LH a swing operation in a microscopic unit. Accordingly, in order to conduct the tracking operation, it is required to give the lens holder LH a subtle swing operation while maintaining the condition that the tracking coils 21A and 21B respectively oppose to the magnets 22A and 22B.

In order to conduct the tracking operation described above, an iron piece is provided on the inside of respective tracking coils 21A and 21B. An operation control circuit controls the electric current in the tracking coils 21A and 21B so that the subtle repulsive force is generated between magnets and respective iron piece while these magnets attract the respective iron pieces.

Next, the main body of the optical pickup apparatus will be described. In this embodiment, when recording and/or reproducing information for the four types of optical discs, the lens holder LH of the objective lens actuator mechanism 10 is rotated so that either the objective optical system OBJ1 or the objective optical system OBJ2 is positioned in the optical path as shown in FIG. 1. In this embodiment, the second semiconductor laser LD2 and the third semiconductor laser LD3, which are attached on the same board in the same package, configure a single unit called two laser in one package 2L1P. Further, the effective diameters of the objective optical systems OBJ1 and OBJ2 are equal. An incidence optical system includes a beam shaper BS, a dichroic prism DP, a polarized beam splitter PBS, a collimator lens COL, which is a coupling lens, and a λ/4 wavelength plate QWP.

Here, the objective optical system OBJ1 has a structure that a mirror frame MF connects the liquid crystal correction element LCD and the objective lens L1 and the objective optical system is fixed on the lens holder LH. Namely, when the objective lens moves, the liquid crystal correction element LCD also moves. Therefore, the light flux having passed through the objective lens OBJ1 definitely passes through the objective lens L1 and the liquid crystal correction element LCD, which structure the objective optical system OBJ1. The numerical aperture NA of the objective lens L1 is preferably equal to or more than 0.6.

The objective lens L1 has been appropriately designed to be the most suitable for the protective layer having thickness t1 of the first optical disk. The liquid crystal correction element LCD has been designed to provide appropriate spherical aberration so that the light flux, which has passed through the objective lens L1, forms an appropriate converged spot on the information recording surface after passing through the protective layer t2 of the second optical disk.

For example, it is preferable to differentiate the amount of the spherical aberration corrected when recording and/or reproducing information for the optical disk OD1 from the amount of spherical aberration corrected when recording and/or reproducing information for the optical disk OD2. Further, it is preferable that both when information is recorded and/or reproduced on the optical disk OD1 and when information is recorded and/or reproduced on the optical disk OD2, the amount of a spherical aberration ΔSA corrected by the liquid crystal correction element LCD, satisfies a following conditional expression within the numerical aperture NA of 0.6 of the objective lens L1 of the objective optical system OBJ1.

0.8<|ΔSA(WFEλrms)|<1.6

In order to record and/or reproduce information for the high-density optical disk more properly, it is more preferable that the amount ΔSA satisfies the above formula within the numerical aperture NA 0.65 of the objective lens L1 of the objective optical system OBJ1.

On the other hand, the objective optical system OBJ2 includes a compatible objective lens for DVD/CD and includes an optical surface on which a diffractive structure for correcting spherical aberration caused by the thickness difference between the optical discs OD3 and OD4, is formed.

FIG. 3 illustrates a cross sectional view of a schematic structure of a liquid crystal correction element LCD. The liquid crystal correction element LCD has the layered structure including an insulation substrate SUB (which is a glass plate or a plastic plate having higher strength than a liquid crystal element); an electrode plate EP; the insulation substrate SUB; the liquid crystal element LC including a molecular arrangement layer deployed in a rotationally symmetrical configuration with respect to the optical axis; the electrode plate EP and the insulation substrate SUB, which are layered in this order in the optical axis direction. At least one electrode plate within the electrode plates EP is divided into ring-shaped patterns centering on the optical axis.

Power supply PS, which is a voltage supply device, applies predetermined driving voltage onto the electrode plate EP, which has been divided into the ring-shaped patters as described above, by using the spherical aberration change signal of the converged spot formed on an information recording surface DR based on the output signal of a an optical detector, which will be described later. At that time, the arrangement pattern of the molecular arrangement layer of the liquid crystal element layer LC changes in a ring shape. As a result, it becomes possible to make the liquid crystal correction element LCD possess a ring-shaped refractive index distribution. The spherical aberration is added on the wavefront of the light flux, which has passed through the liquid crystal correction element LCD having the ring-shaped refractive index distribution. Therefore, it allows to correct the change in spherical aberration caused by the thickness of the protective layer by using the liquid crystal correction element LCD. Further, when providing a discrimination device (not shown) of the optical disk in the optical pickup and changing the driving voltage to be inputted from the power supply PS so as to differentiate the arrangement patterns of the molecular arrangement of the liquid crystal element layer LC caused when recording and/or reproducing information for the optical disk OD1 and when recording and/or reproducing information for the optical disk OD2, the aberration correction corresponding to the optical disk automatically becomes possible.

There may be provided a pair of insulation plates USB, one of which is provided as a correction plate and include a diffractive structure having a concentric ring shape centering on the optical axis on the surface (the other of which is provided as a flat plate). The diffractive structure described above may be applied to correct the coma aberration of the light flux, which passes through the diffractive structure.

[When Recording and/or Reproducing Information for First Optical Disk OD1]

The lens holder LH of the objective lens actuator mechanism 10 is rotationally driven and the objective optical system OBJ1 is inserted in the optical path. Here, the liquid crystal correction element LCD is in a turn-off state. The first semiconductor laser LD1 as the first light source (wavelength λ1=400 nm to 420 nm) emits a light flux and the beam shaper BS correct the beam shape of the first light flux. The light flux emitted from the first semiconductor laser LD1 passes through the dichroic prism DP and the polarized beam splitter PBS, and is converted into a collimated light flux by the collimator lens COL, which is a coupling lens, which does not move in the optical axis direction. Then, the light flux emitted from the first semiconductor laser LD1 passes though the λ/4 wavelength plate QWP and the diaphragm (not shown). Further, the light flux emitted from the first semiconductor laser LD1 is converged and formed into a converged spot on the information recording surface of the first optical disk OD1 through the protective substrate (thickness t1=0.085 to 0.1 mm) by the objective optical system OBJ1.

Then, the light flux is modulated and reflected by the information pits of the information recording surface again and passes through the objective optical system OBJ1, the diaphragm (not shown), the λ/4 wavelength plate QWP, the collimator lens COL and reflected by the polarized beam splitter PBS. Then the light flux modulated and reflected by the information pits of the information recording surface passes through the sensor lens SL and is guided to the light receiving surface of the optical detector PD. The output signal of the optical detector PD is utilized as the read signal of the information recorded on the first optical disk OD1.

Focal point detection and track detection will be conducted by detecting the shape change and the position change of the converged spot on the optical detector PD. Based on this detection, the focusing actuator (not shown) and the tracking actuator 20 of the objective lens actuator mechanism 10 are arranged to move the objective optical system OBJ1 as one body so that the light flux from the first semiconductor laser LD1 is formed into an image on the information recording surface of the first optical disk OD1.

[When Recording and/or Reproducing Information for Second Optical Disk OD2]

The lens holder LH of the objective lens actuator mechanism 10 is rotationally driven and the objective optical system OBJ1 is inserted in the optical path. Here, the liquid crystal correction element LCD is in a turn-on state. The first semiconductor laser LD1 (wavelength λ1=400 nm to 420 nm) as the first semiconductor laser emits the light flux and beam shape of the light flux emitted from the first light source is corrected by a beam shaper BS. The light flux emitted from the first semiconductor laser LD1 passes through the dichroic prism DP and the polarized beam splitter PBS and is converted into a collimated light flux by the collimator lens COL, which does not move in the optical axis direction. Then, the light flux emitted from the first semiconductor laser LD1 passes though the λ/4 wavelength plate QWP and the diaphragm (not shown). Further, the light flux emitted from the first semiconductor laser LD1 is converged and formed into a converged spot on the information recording surface of the second optical disk OD2 through the protective layer (thickness t2=0.55 to 0.65 mm) by the objective optical system OBJ1, with its spherical aberration being corrected by the liquid crystal correction element LCD.

Then, the light flux is modulated and reflected by the information pits of the information recording surface again and passes through the objective optical system OBJ1, the diaphragm (not shown), the λ/4 wavelength plate QWP and the collimator lens COL, and is reflected by the polarized beam splitter PBS. Then the light flux modulated and reflected by the information pits of the information recording surface passes through the sensor lens SL and is guided to the light receiving surface of the optical detector PD. The output signal of the optical detector PD is utilized as the read signal of the information recorded on the second optical disk OD2.

Focal point detection and track detection will be conducted by detecting the shape change and the position change of the converged spot on the optical detector PD. Based on this detection, the focusing actuator (not shown) and the tracking actuator 20 of the objective lens actuator mechanism 10 are arranged to move the objective optical system OBJ1 as one body so that the light flux from the first semiconductor laser LD1 is formed into an image on the information recording surface of the second optical disk OD2.

[When Recording and/or Reproducing Information for Third Optical Disk OD3]

The lens holder LH of the objective lens actuator mechanism 10 is rotationally driven and the objective optical system OBJ2 is inserted in the optical path. The second semiconductor laser LD2 (wavelength λ2=640 nm to 670 nm) in the two laser one package 2L1P as the second light source emits a light flux and the light flux is reflected by the dichroic prism DP, passes through the polarized beam splitter PBS and is converted into a collimated light flux by the collimator lens COL. Then, the light flux emitted from the second semiconductor laser LD2 passes though the λ/4 wavelength plate QWP and the diaphragm (not shown). Further, the light flux emitted from the second semiconductor laser LD2 is converged and formed into a converged spot on the information recording surface of the third optical disk OD3 through the protective layer (thickness t3=0.55 to 0.65 mm) by the objective optical system OBJ2.

Then, the light flux is modulated and reflected by the information pits of the information recording surface again and passes through the objective optical system OBJ2, the diaphragm (not shown), the λ/4 wavelength plate QWP and the collimator lens COL, and is reflected by the polarized beam splitter PBS. Then the light flux modulated and reflected by the information pits of the information recording surface passes through the sensor lens SL and is guided to the light receiving surface of the optical detector PD. The output signal of the optical detector PD is utilized as the read signal of the information recorded on the third optical disk OD3.

Focal point detection and track detection will be conducted by detecting the shape change and the position change of the converged spot on the optical detector PD. Based on this detection, the focusing actuator (not shown) and the tracking actuator 20 of the objective lens actuator mechanism 10 are arranged to move the objective optical system OBJ2 as one body so that the light flux from the second semiconductor laser LD2 is formed into an image on the information recording surface of the third optical disk OD3.

[When Recording and/or Reproducing Information for Fourth Optical Disk OD4]

The lens holder LH of the objective lens actuator mechanism 10 is rotationally driven and the objective optical system OBJ2 is inserted in the optical path. The third semiconductor laser LD3 (wavelength λ3=750 nm to 820 nm) in the two laser one package 2L1P as the third light source light flux emits a light flux and the light flux is reflected by the dichroic prism DP, passes through the polarized beam splitter PBS and is converted into a collimated light flux by the collimator lens COL. Then, the light flux emitted from the third semiconductor laser LD3 passes though the λ/4 wavelength plate QWP and the diaphragm (not shown). Further, the light flux emitted from the third semiconductor laser LD3 is converged and formed into a converged spot on the information recording surface of the fourth optical disk OD4 through the protective layer (thickness t4=1.1 to 1.3 mm) by the objective optical system OBJ2.

Then, the light flux is modulated and reflected by the information pits of the information recording surface again and passes through the objective optical system OBJ2, the diaphragm (not shown), the λ/4 wavelength plate QWP and the collimator lens COL, and is reflected by the polarized beam splitter PBS. Then the light flux modulated and reflected by the information pits of the information recording surface passes through the sensor lens SL and is guided to the light receiving surface of the optical detector PD. The output signal of the optical detector PD is utilized as the read signal of the information recorded on the fourth optical disk OD4.

Focal point detection and track detection will be conducted by detecting the shape change and the position change of the converged spot on the optical detector PD. Based on this detection, the focusing actuator (not shown) and the tracking actuator 20 of the objective lens actuator mechanism 10 are arranged to move the objective optical system OBJ2 as one body so that the light flux from the second semiconductor laser LD2 is formed into an image on the information recording surface of the fourth optical disk OD4.

### Second Embodiment

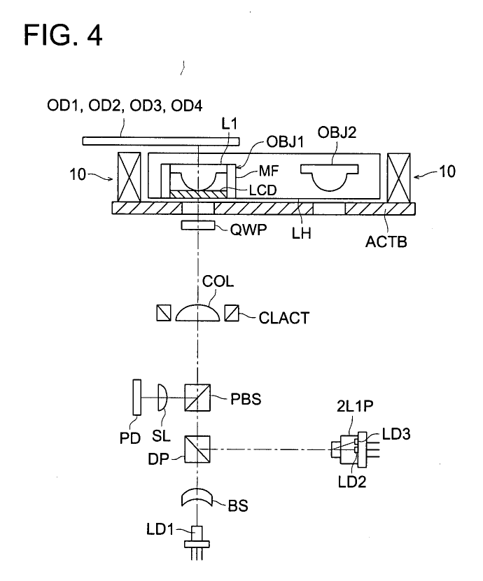

FIG. 4 illustrates a schematic cross sectional view for the optical pickup apparatus of the second embodiment of the present invention. The embodiment illustrated in FIG. 4 is different from the embodiment illustrated in FIG. 1 in only one point that the collimator lens COL, which is a coupling lens, is moved in the optical axis direction by an actuator CLACT. The light flux emitted from the semiconductor laser and the light flux reflected by the information recording surface are enters into the collimator lens COL, which is a coupling lens, before the light flux is formed into a collimated light flux by a function of any other element.

When the first optical disk OD1 through third optical disk OD3 have plural layers of information recording surfaces, the actuator CLACT appropriately moves the collimator lens COL in order to appropriately record and/or reproduce information for respective recording surfaces.

Further, it is preferable that both when information is recorded and/or reproduced on the optical disk OD1 and when information is recorded and/or reproduced on the optical disk OD2, the amount of a spherical aberration ΔSA corrected by the collimator lens COL which is the coupling lens, satisfies a following conditional expression within the numerical aperture NA of 0.6 of the objective lens L1 of the objective optical system OBJ1.

0.8<|ΔSA(WFEλrms)|<1.6

In order to record and/or reproduce information for the high-density optical disk, it is more preferable that the amount ΔSA satisfies the above formula within the numerical aperture NA 0.65 of the objective lens L1 of the objective optical system OBJ1.

Since the structure other than that is the same as the structure employed in the embodiment illustrated in FIG. 1, the same symbol is put on the same element and the explanation is omitted here. The lens holder LH may be driven in a straight-line motion rather than rotational motion.

### Third Embodiment

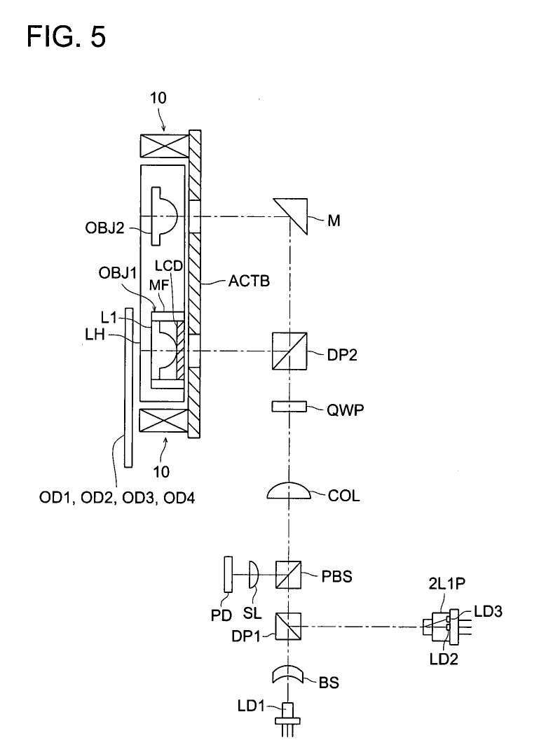

FIG. 5 illustrates a schematic structural view for the optical pickup apparatus of the third embodiment of the present invention. The embodiment illustrated in FIG. 5 is different from the embodiment illustrated in FIG. 1 as following. In the embodiment illustrated in FIG. 5, the lens holder LH does not rotate against the actuator base ACTB, and is supported so as to be capable of moving in a tracking direction and a focusing direction. Other than those points, the embodiment illustrated in FIG. 5 is the same as the embodiment illustrated in FIG. 1. Here, a beam shaper BS, a dichroic prism DP, a polarized beam splitter PBS, a collimator lens COL and a λ/4 wavelength plate QWP configure an incidence optical system.

[When Recording and/or Reproducing Information for First Optical Disk OD1]

The liquid crystal correction element LCD is in a turn-off state. The first semiconductor laser LD1 (wavelength λ1=400 nm to 420 nm) as the first light source emits a light flux and the beam shape of the light flux is corrected by a beam shaper BS. The light flux emitted from the first semiconductor laser LD1 passes through the first dichroic prism DP1 and the polarized beam splitter PBS, and is converted into a collimated light flux by the collimator lens COL, which is a coupling lens, which does not move in the optical axis direction. Then, the light flux emitted from the first semiconductor laser LD1 passes though the λ/4 wavelength plate QWP and is reflected by the second dichroic prism DP2. Further, the light flux emitted from the first semiconductor laser LD1 passes through a diaphragm (not shown), is converged and formed into a converged spot on the information recording surface of the first optical disk OD1 through the protective layer (thickness t1=0.085 to 0.1 mm) by the objective optical system OBJ1.

Then, the light flux is modulated and reflected by the information pits of the information recording surface again, passes through the objective optical system OBJ1, the diaphragm (not shown), the second dichroic prism DP2, the λ/4 wavelength plate QWP, the collimator lens COL and is reflected by the polarized beam splitter PBS. Then the light flux modulated and reflected by the information pits of the information recording surface passes through the sensor lens SL and is guided to the light receiving surface of the optical detector PD. The output signal of the optical detector PD is utilized as the read signal of the information recorded on the first optical disk OD1.

Focal point detection and track detection will be conducted by detecting the shape change and the position change of the converged spot on the optical detector PD. Based on this detection, the focusing actuator (not shown) and the tracking actuator 20 of the objective lens actuator mechanism 10 are arranged to move the objective optical system OBJ1 as one body so that the light flux from the first semiconductor laser LD1 is formed into an image on the information recording surface of the first optical disk OD1.

[When Recording and/or Reproducing Information for Second Optical Disk OD2]

Here, the liquid crystal correction element LCD is in a turn-on state. The first semiconductor laser LD1 (wavelength λ1=400 nm to 420 nm) as the first light source emits a light flux and the beam shape of the light flux is corrected by a beam shaper BS. The light flux emitted from the first semiconductor laser LD1 passes through the first dichroic prism DP1 and the polarized beam splitter PBS, and is converted into a collimated light flux by the collimator lens COL, which is a coupling lens, which does not move in the optical axis direction. Then, the light flux emitted from the first semiconductor laser LD1 passes though the λ/4 wavelength plate QWP and is reflected by the second dichroic prism DP2. Further, the light flux emitted from the first semiconductor laser LD1 passes through a diaphragm (not shown), is converged and is formed into a converged spot on the information recording surface of the second optical disk OD2 through the protective layer (thickness t2=0.55 to 0.65 mm) by the objective optical system OBJ1, with its spherical aberration being corrected by the liquid crystal correction element LCD.

Then, the light flux is modulated and reflected by the information pits of the information recording surface again, passes through the objective optical system OBJ1 and the diaphragm (not shown), is reflected by the second dichroic prism, then, passes through the λ/4 wavelength plate QWP and the collimator lens COL, and is reflected by the polarized beam splitter PBS. Then the light flux modulated and reflected by the information pits of the information recording surface passes through the sensor lens SL and is guided to the light receiving surface of the optical detector PD. The output signal of the optical detector PD is utilized as the read signal of the information recorded on the second optical disk OD2.

Focal point detection and track detection will be conducted by detecting the shape change and the position change of the converged spot on the optical detector PD. Based on this detection, the focusing actuator (not shown) and the tracking actuator 20 of the objective lens actuator mechanism 10 are arranged to move the objective optical system OBJ1 as one body so that the light flux from the first semiconductor laser LD1 is formed in an image on the information recording surface of the second optical disk OD2.

[When Recording and/or Reproducing Information for Third Optical Disk OD3]

The second semiconductor laser LD2 (wavelength λ2=640 nm-670 nm) in the two laser one package 2L1P as the second light source emits a light flux and the light flux is reflected by the first dichroic prism DP1, passes through the polarized beam splitter PBS and is converted into a collimated light flux by the collimator lens COL. Then, the light flux emitted from the second semiconductor laser LD2 passes though the λ/4 wavelength plate QWP and the second dichroic prism DP2 (along the different optical path of the light flux having wavelength of λ1). Then the light flux passes though the diaphragm (not shown) after being reflected by the mirror M. Further, the light flux emitted from the second semiconductor laser LD2 is converged and formed into a converged spot on the information recording surface of the third optical disk OD3 through the protective layer (thickness t3=0.55 to 0.65 mm) by the objective optical system OBJ2.

Then, the light flux is modulated and reflected by the information pits of the information recording surface again, and passes through the objective optical system OBJ2 and the diaphragm (not shown). Then the light flux passes though the second dichroic prism DP2 and the λ/4 wavelength plate QWP after being reflected by the mirror M. Then the light flux passes though the collimator lens COL and is reflected by the polarized beam splitter PBS. Then the light flux modulated and reflected by the information pits of the information recording surface passes through the sensor lens SL and is guided to the light receiving surface of the optical detector PD. The output signal of the optical detector PD is utilized as the read signal of the information recorded on the third optical disk OD3.

Focal point detection and track detection will be conducted by detecting the shape change and the position change of the converged spot on the optical detector PD. Based on this detection, the focusing actuator (not shown) and the tracking actuator 20 of the objective lens actuator mechanism 10 are arranged to move the objective optical system OBJ2 as one body so that the light flux from the second semiconductor laser LD2 is formed into an image on the information recording surface of the third optical disk OD3.

[When Recording and/or Reproducing Information for Fourth Optical Disk OD4]

The third semiconductor laser LD3 (wavelength λ3=750 nm to 820 nm) in the two laser one package 2L1P as the second light source emits a light flux and the light flux is reflected by the first dichroic prism DP1, passes through the polarized beam splitter PBS and is converted into a collimated light flux by the collimator lens COL. Then, the light flux emitted from the third semiconductor laser LD3 passes though the λ/4 wavelength plate QWP and the second dichroic prism DP2. Then the light flux passes though the diaphragm (not shown) after being reflected by the mirror M. Further, the light flux emitted from the third semiconductor laser LD3 is converged and formed into a converged spot on the information recording surface of the fourth optical disk OD4 through the protective layer (thickness t4=1.1 to 1.3 mm) by the objective optical system OBJ2.

Then, the light flux is modulated and reflected by the information pits of the information recording surface again and passes through the objective optical system OBJ2 and the diaphragm (not shown). Then the light flux passes though the second dichroic prism DP2 and the λ/4 wavelength plate QWP after being reflected by the mirror M. Then the light flux passes though the collimator lens COL and is reflected by the polarized beam splitter PBS. Then the light flux modulated and reflected by the information pits of the information recording surface passes through the sensor lens SL and is guided to the light receiving surface of the optical detector PD. The output signal of the optical detector PD is utilized as the read signal of the information recorded on the fourth optical disk OD4.

Focal point detection and track detection will be conducted by detecting the shape change and the position change of the converged spot on the optical detector PD. Based on this detection, the focusing actuator (not shown) and the tracking actuator 20 of the objective lens actuator mechanism 10 are arranged to move the objective optical system OBJ2 as one body so that the light flux from the second semiconductor laser LD2 is formed into an image on the information recording surface of the fourth optical disk OD4.

### Fourth Embodiment

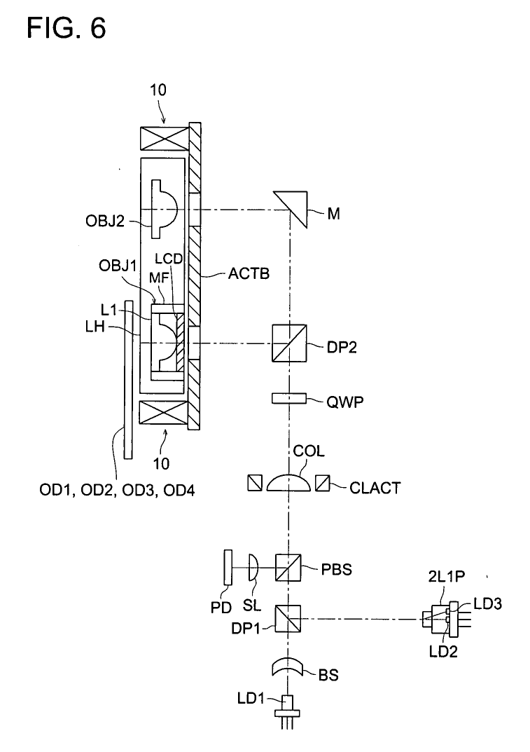

FIG. 6 illustrates the schematic structural view of the optical pickup apparatus of the fourth embodiment of the present invention. The embodiment illustrated in FIG. 4 is different from the embodiment illustrated in FIG. 5 as following. Comparing with the embodiment illustrated in FIG. 5, there is a different point that in the fourth embodiment, the actuator CLACT is capable of moving the collimator lens COL in the optical axis direction. The light flux emitted from the semiconductor laser and the light flux reflected by the information recoding surface are guided into the collimator lens, which is a coupling lens, before the light flux is formed into a collimated light flux by a function of the other optical element.

When the first optical disk OD1 through third optical disk OD3 have plural layers of information recording surfaces, in order to appropriately record and/or reproduce information for respective recording surfaces, the actuator CLACT appropriately move the collimator lens COL.

Further, both when information is recorded and/or reproduced on the optical disk OD1 and when information is recorded and/or reproduced in the optical disk OD2, the amount of a spherical aberration ΔSA corrected by the collimator lens COL which is the coupling lens, satisfies a following conditional expression within the numerical aperture NA of 0.6 of the objective lens L1 of the objective optical system OBJ1.

0.8<|ΔSA(WFEλrms)|<1.6

In order to record and/or reproduce information for the high-density optical disk more properly, it is more preferable that the amount ΔSA satisfies the above formula within the numerical aperture NA 0.65 of the objective lens L1 of the objective optical system OBJ1.

Since the structure other than that is the same as the structure employed in the embodiment illustrated in FIG. 5, the same symbol is put and the explanation is omitted here.

### Fifth Embodiment

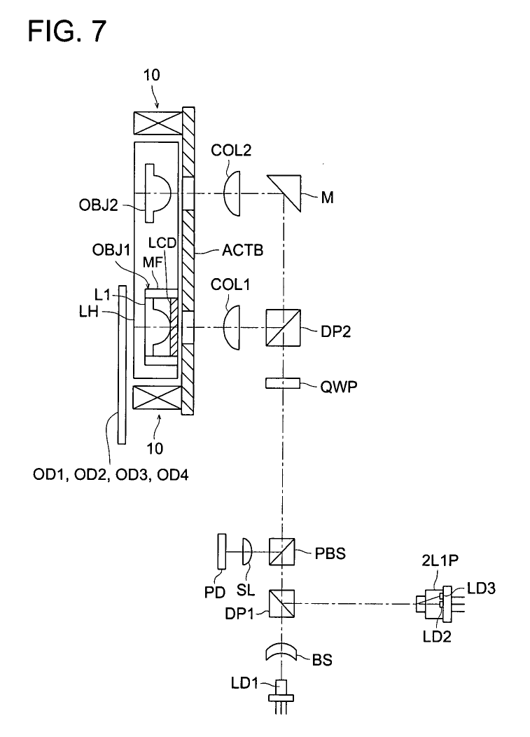

FIG. 7 illustrates a schematic structural view for the optical pickup apparatus of the fifth embodiment of the present invention. The embodiment illustrated in FIG. 7 is different from the embodiment illustrated in FIG. 1 as following. In the embodiment illustrated in FIG. 7, the lens holder LH does not rotate against the actuator base ACTB, and is supported so as to move in a tracking direction and a focusing direction. Other than those points, the embodiment illustrated in FIG. 7 is the same as the embodiment illustrated in FIG. 1. Here, a beam shaper BS, a first dichroic prism DP1, a polarized beam splitter PBS, a first dichroic prism DP1, a polarized beam splitter PBS, a λ/4 wavelength plate QWP, the second dichroic prism DP2, a mirror M, a first collimator lens COL1 and a second collimator lens COL2 configure an incidence optical system.

[When Recording and/or Reproducing Information for the First Optical Disk OD1]

The liquid crystal correction element LCD is in a turn-off state. The first semiconductor laser LD1 (wavelength λ1=400 nm-420 nm) as the first light source emits a light flux and the beam shape of the light flux is corrected by a beam shaper BS. The light flux emitted from the first semiconductor laser LD1 passes through the first dichroic prism DP1, the polarized beam splitter PBS and the λ/4 wavelength plate QWP. The light flux emitted from the first semiconductor laser LD1 is reflected by the second dichroic prism DP2 and converted into a collimated light flux by the first collimator lens COL1, which is a coupling lens, which does not move in the optical axis direction. Further, the light flux emitted from the first semiconductor laser LD1 passes through a diaphragm (not shown), is converged and is formed into a converged spot on the information recording surface of the first optical disk OD1 through the protective layer (thickness t1=0.085 to 0.1 mm) by the objective optical system OBJ1.

Then, the light flux is modulated and reflected by the information pits of the information recording surface again and passes through the objective optical system OBJ1, the diaphragm (not shown) and the first collimator lens COL1. The light flux modulated and reflected by the information pits of the information recording surface is then reflected by the second dichroic prism DP2, and passes though the λ/4 wavelength plate QWP. Then the light flux is reflected by the polarized beam splitter PBS, and passes through the sensor lens SL and is guided to the light receiving surface of the optical detector PD. The output signal of the optical detector PD is utilized as the read signal of the information recorded on the first optical disk OD1.

Focal point detection and track detection will be conducted by detecting the shape change and the position change of the converged spot on the optical detector PD. Based on this detection, the focusing actuator (not shown) and the tracking actuator 20 of the objective lens actuator mechanism 10 are arranged to move the objective optical system OBJ1 as one body so that the light flux from the first semiconductor laser LD1 is formed into an image on the information recording surface of the first optical disk OD1.

[When Recording and/or Reproducing Information for Second Optical Disk OD2]

Here, the liquid crystal correction element LCD is in a turn-on state. The first semiconductor laser LD1 (wavelength λ1=400 nm to 420 nm) as the first light source emits a light flux and the beam shape of the light flux is corrected by a beam shaper BS. The light flux emitted from the first semiconductor laser LD1 passes through the first dichroic prism DP1 and the polarized beam splitter PBS. Then, the light flux emitted from the first semiconductor laser LD1 passes though the λ/4 wavelength plate QWP and is reflected by the second dichroic prism DP2. Further, the light flux emitted from the first semiconductor laser LD1 passes through a diaphragm (not shown) after being formed into a collimated light flux by the first collimator lens COL1, and is converged and is formed into a converged spot on the information recording surface of the second optical disk OD2 through the protective layer (thickness t2=0.55 to 0.65 mm) by the objective optical system OBJ1, with its spherical aberration being corrected with the liquid crystal correction element LCD.

Then, the light flux is modulated and reflected by the information pits of the information recording surface again and passes through the objective optical system OBJ1, the diaphragm (not shown) and the first collimator lens COL1. The light flux modulated and reflected by the information pits of the information recording surface is then reflected by the second dichroic prism DP2, and passes though the λ/4 wavelength plate QWP. Then the light flux is reflected by the polarized beam splitter PBS, passes through the sensor lens SL and is guided to the light receiving surface of the optical detector PD. The output signal of the optical detector PD is utilized as the read signal of the information recorded on the second optical disk OD2.

Focal point detection and track detection will be conducted by detecting the shape change and the position change of the converged spot on the optical detector PD. Based on this detection, the focusing actuator (not shown) and the tracking actuator 20 of the objective lens actuator mechanism 10 are arranged to move the objective optical system OBJ1 as one body so that the light flux from the first semiconductor laser LD1 is formed into an image on the information recording surface of the second optical disk OD2.

[When Recording and/or Reproducing Information for Third Optical Disk OD3]

The second semiconductor laser LD2 in the two laser one package 2L1P (wavelength λ2=640 nm to 670 nm) as the second light source emits a light flux and the light flux is reflected by the first dichroic prism PD1. The light flux emitted from the second semiconductor laser LD2 passes through the polarized beam splitter PBS and the λ/4 wavelength plate QWP and the second dichroic prism DP2. Then, the light flux emitted from the second semiconductor laser LD2 is reflected by the mirror M and converted into a collimated light flux by the second collimator lens COL2, which is a coupling lens, which does not move in the optical axis direction. Further, the light flux emitted from the second semiconductor laser LD2 passes through a diaphragm (not shown), is converged and is formed into a converged spot on the information recording surface of the third optical disk OD3 through the protective layer (thickness t3=0.55 to 0.65 mm) by the objective optical system OBJ2.

Then, the light flux is modulated and reflected by the information pits of the information recording surface again and passes through the objective optical system OBJ2, the diaphragm (not shown) and the second collimator lens COL2. The light flux modulated and reflected by the information pits of the information recording surface is then reflected by the mirror M, and passes though the second dichroic prism DP2 and the λ/4 wavelength plate QWP. Then the light flux is reflected by the polarized beam splitter PBS, passes through the sensor lens SL and is guided to the light receiving surface of the optical detector PD. The output signal of the optical detector PD is utilized as the read signal of the information recorded on the third optical disk OD3.

Focal point detection and track detection will be conducted by detecting the shape change and the position change of the converged spot on the optical detector PD. Based on this detection, the focusing actuator (not shown) and the tracking actuator 20 of the objective lens actuator mechanism 10 are arranged to move the objective optical system OBJ1 as one body so that the light flux from the second semiconductor laser LD2 is formed into an image on the information recording surface of the third optical disk OD3.

[When Recording and/or Reproducing Information for Fourth Optical Disk OD4]

The third semiconductor laser LD3 in the two laser one package 2L1P (wavelength λ3=750 nm to 820 nm) as the third light source emits a light flux and the light flux is reflected by the first dichroic prism PD1. The light flux emitted from the third semiconductor laser LD3 passes through the polarized beam splitter PBS and the λ/4 wavelength plate QWP and the second dichroic prism DP2. Then, the light flux emitted from the third semiconductor laser LD3 is reflected by the mirror M and converted into a collimated light flux by the second collimator lens COL2, which is a coupling lens, which does not move in the optical axis direction. Further, the light flux emitted from the third semiconductor laser LD3 passes through a diaphragm (not shown), is converged and is formed into a converged spot on the information recording surface of the fourth optical disk OD4 through the protective layer (thickness t4=1.1 to 1.3 mm) by the objective optical system OBJ2.

Then, the light flux is modulated and reflected by the information pits of the information recording surface again and passes through the objective optical system OBJ2, the diaphragm (not shown) and the second collimator lens COL2. The light flux modulated and reflected by the information pits of the information recording surface is then reflected by the mirror M, and passes though the second dichroic prism DP2 and the λ/4 wavelength plate QWP. Then the light flux is reflected by the polarized beam splitter PBS, passes through the sensor lens SL and is guided to the light receiving surface of the optical detector PD. The output signal of the optical detector PD is utilized as the read signal of the information recorded on the fourth optical disk OD4.

Focal point detection and track detection will be conducted by detecting the shape change and the position change of the converged spot on the optical detector PD. Based on this detection, the focusing actuator (not shown) and the tracking actuator 20 of the objective lens actuator mechanism 10 are arranged to move the objective optical system OBJ1 as one body so that the light flux from the second semiconductor laser LD2 is formed into an image on the information recording surface of the fourth optical disk OD4.

### Sixth Embodiment

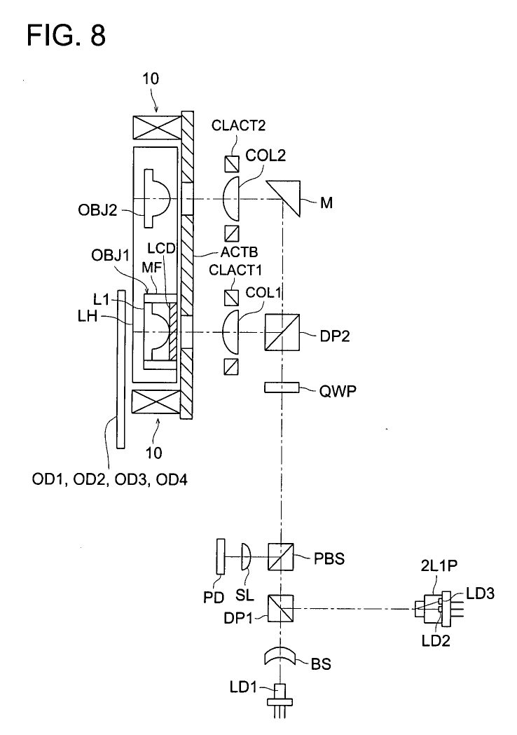

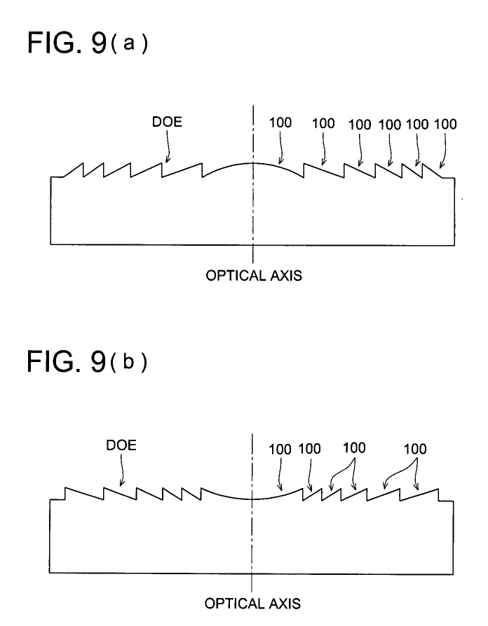

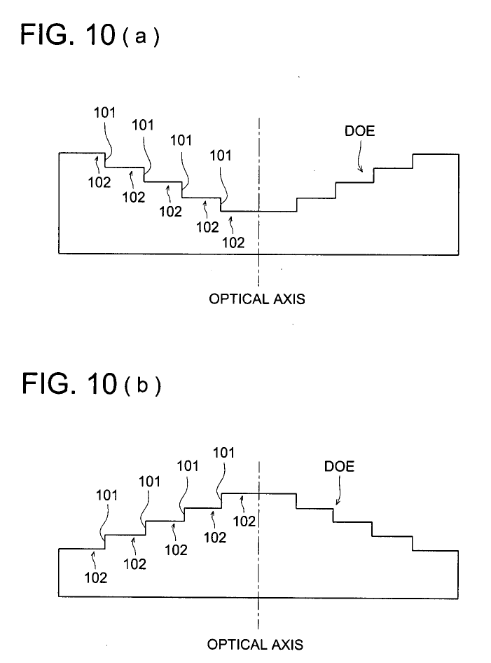

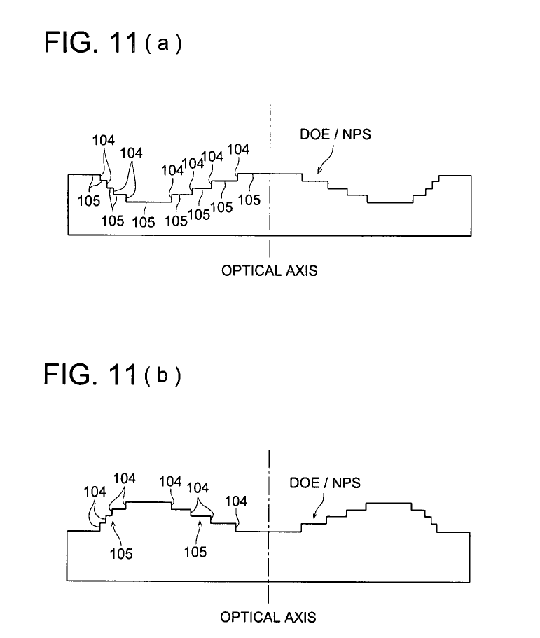

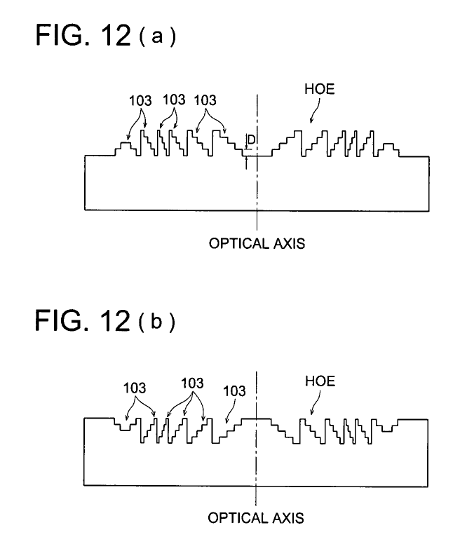

FIG. 8 illustrates a schematic structural view for the optical pickup apparatus of the sixth embodiment of the present invention. The embodiment illustrated in FIG. 6 is different from the embodiment illustrated in FIG. 7 as following. In the sixth embodiment, the first actuator CLACT1 is arranged to move the first collimator lens COL1 in the optical axis direction and the second actuator CLACT2 is arranged to move the second collimator lens COL2 in the optical axis direction. The light fluxes emitted from the semiconductor lasers and reflected by the information recording surfaces enter into the collimator lenses COL1 and COL2 before each of the light fluxes is formed into a collimated light flux by a function of the other optical element.

When the first optical disk OD1 through third optical disk OD3 have plural layers of information recording surfaces, in order to appropriately record and/or reproduce information onto or from respective recording surfaces, the actuators CLACT1 and CLACT2 appropriately move the collimator lenses COL1 and COL2.

Further, both when information is recorded and/or reproduced on the optical disk OD1 and when information is recorded and/or reproduced on the optical disk OD2, the amount of a spherical aberration ΔSA corrected by collimator lenses COL which are the coupling lenses along the optical axis, satisfies a following conditional expression within the numerical aperture NA of 0.6 of the objective lens L1 of the objective optical system OBJ1.

0.8<|ΔSA(WFEλrms)|<1.6

In order to record and/or reproduce information for the high-density optical disk more properly, it is preferable that the amount ΔSA satisfies the above formula within the numerical aperture NA 0.65 of the objective lens L1 of the objective optical system OBJ1.

It is also possible to move the collimator lenses COL1 and COL2, which are held as one body by a holding member, by a single actuator. The collimator lenses COL1 and COL2 may be formed in one body by resin material. Further, any one of the collimator lenses may be arranged to be a structure, which is capable of moving.

Since the structure other than that is the same as the structure employed in the embodiment illustrated in FIG. 5, the same symbol is put and the explanation is omitted here.

In the embodiments described above, the diffractive structure for improving the wavelength characteristic and the temperature characteristic may be arbitrarily provided on the collimator lens. When moving the collimator lens, either of the amount of spherical surface aberration corrected based on the movement of the collimator lens or the amount of spherical aberration corrected by the liquid crystal correction element may be set larger than the other. Instead of optimizing the objective lens L1 of the first objective optical system for the first optical disk OD1 having the protective layer having thickness of t1, it may be possible to optimize the objective lens L1 of the first objective optical system for the second optical disk OD2 having the protective layer having thickness of t2 or to optimize against the thickness of t5, which is between the thickness of t1 and the thickness of t2.

For example, the amount of spherical aberration Δ1 caused when converging the first light flux onto the recording medium through the protective layer of the first optical disk OD1 by using the objective lens L1, the amount of spherical aberration Δ2 caused when converging the first light flux onto the recording medium through the protective layer of the second optical disk OD2 and the amount of spherical aberration Δ5 caused when converging the first light flux onto the recording medium through the protective layer with thinness of t5 (t2>t5>t1) may be designed so as to satisfy Δ1>Δ5 and Δ2>Δ5, or to satisfy Δ1<Δ5<Δ2.

Using a three-lasers-in-one-package, into which the semiconductor lasers of three different wavelengths have been installed, instead of the first semiconductor laser, will provide a simple structure.

In the embodiments described above, the material of optical elements in the first objective optical system and the second objective optical system have not been specified. However, it is preferable that at least one optical element in the first objective optical system the second optical system is formed of plastic resin, in which inorganic microparticles having diameter, which is equal to or less than 30 nm, are dispersed and has has an amount |dn/dT| of a change in a refractive index with a temperature change being less than 8×10⁻⁵. Alternatively, it is preferable that at least one optical element in the first objective optical system the second optical system is formed of glass, and has an amount |dn/dT| of a change in a refractive index with a temperature change being less than 5×10⁻⁵.

1. An optical pickup apparatus, comprising:
a first light source for emitting a first light flux having a wavelength λ1;
a second light source for emitting a second light flux having a wavelength λ2 (λ2>λ1);
a third light source for emitting a third light flux having a wavelength λ3 (λ3>λ2);
a first objective optical system;
a second objective optical system;
an incidence optical system for emitting the first to third light fluxes into one of the first objective optical system and the second objective optical system; and
an optical detector,
wherein the first objective optical system is adopted to converge the first light flux with the wavelength λ1 emitted by the first light source onto an information recording surface of a first optical information recording medium having a first protective layer whose thickness is t1 so that the optical pickup apparatus conducts reproducing and/or recording information for the first optical information recording medium,
wherein the first objective optical system is adopted to converge the first light flux onto an information recording surface of a second optical information recording medium having a second protective layer whose thickness is t2 (t2>t1) so that the optical pickup apparatus conducts reproducing and/or recording information for the second optical information recording medium,
wherein the second objective optical system is adopted to converge the second light flux with the wavelength λ2 emitted by the second light source onto an information recording surface of a third optical information recording medium having a third protective layer whose thickness is t3 (t3>t1) so that the optical pickup apparatus conducts reproducing and/or recording information for the third optical information recording medium,
wherein the second objective optical system is adopted to converge the third light flux with the wavelength λ3 emitted by the third light flux onto an information recording surface of a fourth optical information recording medium having a fourth protective layer whose thickness is t4 (t4>t3) so that the optical pickup apparatus conducts reproducing and/or recording information for the fourth optical information recording medium,
wherein the first objective optical system comprises an objective lens, and a liquid crystal correction element being adopted to correct an amount of a spherical aberration of a light flux passing through the liquid crystal correction element, and
wherein the incidence optical system comprises an optical element arranged statically along at least an optical axis.

2. The optical pickup apparatus of claim 1, further comprising:
a holder for holding the first objective optical system and the second objective optical system,
wherein the incidence optical system comprises a coupling lens where the first light flux to the third light flux commonly pass through, and
the holder is driven so that one of the first objective optical system and the second objective optical system receives a light flux having passed through the coupling lens.

3. The optical pickup apparatus of claim 1 or 2,
wherein the incidence optical system comprises
a first coupling lens for transmitting a light flux to enter into the first objective optical system and
a second coupling lens for transmitting a light flux to enter into the second objective optical system, and
wherein a light flux to enter into the first objective optical system travels a different optical path from a light flux to enter into the second objective optical system.

4. An optical pickup apparatus comprising:
a first light source for emitting a first light flux having a wavelength λ1;
a second light source for emitting a second light flux having a wavelength λ2 (λ2>λ1);
a third light source for emitting a third light flux having a wavelength λ3 (λ3>λ2);
a first objective optical system;
a second objective optical system;
an incidence optical system for emitting the first to third light fluxes into one of the first objective optical system and the second objective optical system; and
an optical detector,
wherein the first objective optical system is adopted to converge the first light flux with the wavelength λ1 emitted by the first light source onto an information recording surface of a first optical information recording medium having a first protective layer whose thickness is t1 so that the optical pickup apparatus conducts reproducing and/or recording information for the first optical information recording medium,
wherein the first objective optical system is adopted to converge the first light flux onto an information recording surface of a second optical information recording medium having a second protective layer whose thickness is t2 (t2>t1) so that the optical pickup apparatus conducts reproducing and/or recording information for the second optical information recording medium,
wherein the second objective optical system is adopted to converge the second light flux with the wavelength λ2 emitted by the second light source onto an information recording surface of a third optical information recording medium having a third protective layer whose thickness is t3 (t3>t1) so that the optical pickup apparatus conducts reproducing and/or recording information for the third optical information recording medium,
wherein the second objective optical system is adopted to converge the third light flux with the wavelength λ3 emitted by the third light flux onto an information recording surface of a fourth optical information recording medium having a fourth protective layer whose thickness is t4 (t4>t3) so that the optical pickup apparatus conducts reproducing and/or recording information for the fourth optical information recording medium,
wherein the first objective optical system comprises an objective lens, and a liquid crystal correction element being adopted to correct an amount of spherical aberration of a light flux passing through the liquid crystal correction element, and
wherein the incidence optical system comprises a coupling lens which is movable along an optical axis and transmits a light flux prior to being collimated.

5. The optical pickup apparatus of claim 4,
wherein, in the first objective optical system, the objective lens and the liquid crystal correction element are integrally formed as one body.

6. The optical pickup apparatus of claim 4 or 5,
wherein the incidence optical system comprises
a first coupling lens for transmitting a light flux to enter into the first objective optical system and
a second coupling lens for transmitting a light flux to enter into the second objective optical system, and
wherein a light flux to enter into the first objective optical system travels a different optical path from a light flux to enter into the second objective optical system.

7. The optical pickup apparatus of claim 6, further comprising
a common actuator for driving the first coupling lens and the second coupling lens along the optical axis.

8. The optical pickup apparatus of claim 6, further comprising
an actuator for driving the first coupling lens along the optical axis; and
an actuator for driving the second coupling lens along the optical axis.

9. The optical pickup apparatus of any one of claims 4 to 8,
wherein an amount of a spherical aberration corrected by the liquid crystal correction element is smaller than an amount of a spherical aberration corrected by driving the coupling lens along the optical axis.

10. The optical pickup apparatus of any one of claims 4 to 8,
wherein an amount of a spherical aberration corrected by the liquid crystal correction element is larger than an amount of a spherical aberration corrected by driving the coupling lens along the optical axis.

11. The optical pickup apparatus of any one of claims 4 to 10,
wherein the objective lens in the first objective optical system has a numerical aperture NA of 0.6 or more, and
wherein both when the first light flux is converged on the information recording surface through the first protective layer and when the first light flux is converged on the information recording surface through the second protective layer, an amount ΔSA of a spherical aberration corrected by driving the coupling lens along the optical axis, satisfies a following conditional expression within the numerical aperture NA of 0.6:
0.8<|ΔSA(WFEλrms)|<1.6.

12. The optical pickup apparatus of any one of claims 1 to 11,
wherein the optical detector is a common detector which receives and detects each of the first light flux, the second light flux, and the third light flux.

13. The optical pickup apparatus of any one of claims 1 to 12, satisfying t3>=t2.

14. The optical pickup apparatus of any one of claims 1 to 13,
wherein the objective lens of the first objective optical system has a numerical aperture of 0.6 or more.

15. The optical pickup apparatus of any one of claims 1 to 14,
wherein the objective lens in the first objective optical system has a numerical aperture NA of 0.6 or more, and
wherein both when the first light flux is converged on the information recording surface through the first protective layer and when the first light flux is converged on the information recording surface through the second protective layer, an amount ΔSA of a spherical aberration corrected by the liquid crystal correcting element, satisfies a following conditional expression within the numerical aperture NA of 0.6:
0.8<|ΔSA(WFEλrms)|<1.6.

16. The optical pickup apparatus of any one of claims 1 to 15,
wherein the incidence optical system comprises:
a common coupling lens for transmitting the first to third light fluxes; and
a wavelength selective element for transmitting or reflecting each of the first to third light fluxes having passed through the common coupling lens, depending on a wavelength of the each of the first to third light fluxes.

17. The optical pickup apparatus of any one of claims 1 to 16,
wherein a light flux to enter into the first objective optical system travels a different optical path from a light flux to enter into the second objective optical system.

18. The optical pickup apparatus of any one of claims 1 to 17,
wherein the first objective optical system is adopted to converge the first light flux onto an information recording surface of the first optical information recording medium and an information recording surface of the second optical information recording medium, and
the liquid crystal correcting element corrects the spherical aberration whose amount differs between when the first objective optical system converges the first light flux onto an information recording surface of the first optical information recording medium and when the first objective optical system converges the first light flux onto an information recording surface of the second optical information recording medium.

19. The optical pickup apparatus of any one of claims 1 to 18,
wherein the second objective optical system is adopted to converge the second light flux onto an information recording surface of the third optical information recording medium and to converge the third light flux onto an information recording surface of the fourth optical information recording medium.

20. The optical pickup apparatus of any one of claims 1 to 19,
wherein the objective lens of the first objective optical system is configured to satisfy Δ1>Δ5 and Δ2>Δ5,
where Δ1 is an amount of a spherical aberration caused when the first objective optical system converges the first light flux onto the information recording surface through the first protective layer,
Δ2 is an amount of a spherical aberration caused when the first objective optical system converges the first light flux onto the information recording surface through the second protective layer, and
Δ5 is an amount of a spherical aberration caused when the first objective optical system converges the first light flux onto an information recording surface through a protective layer with a thickness t5 (t2>t5>t1).

21. The optical pickup apparatus of any one of claims 1 to 19,
wherein the objective lens of the first objective optical system is configured to satisfy Δ1<Δ5<Δ2,
where Δ1 is an amount of a spherical aberration caused when the first objective optical system converges the first light flux onto the information recording surface through the first protective layer,
Δ2 is an amount of a spherical aberration caused when the first objective optical system converges the first light flux onto the information recording surface through the second protective layer, and
Δ5 is an amount of a spherical aberration caused when the first objective optical system converges the first light flux onto an information recording surface through a protective layer with a thickness t5 (t2>t5>t1).

22. The optical pickup apparatus of any one of claims 2 to 21,
wherein the incidence optical system comprises a coupling lens, and
the coupling lens comprises an optical surface including a phase structure.

23. The optical pickup apparatus of any one of claims 2 to 21,
wherein the incidence optical system comprises a coupling lens, and
each optical surface of the coupling lens consists of a refractive surface.

24. The optical pickup apparatus of any one of claims 1 to 23,
wherein the first to third light sources are housed in a common package.

25. The optical pickup apparatus of any one of claims 1 to 24,
wherein the second and third light sources are housed in a common package.

26. The optical pickup apparatus of any one of claims 1 to 25,
wherein at least one optical element in the first objective optical system and the second objective optical system comprises a plastic resin in which inorganic microparticles with a diameter of 30 nm or less are dispersed, and has an amount |dn/dT| of a change in a refractive index with a temperature change of less than 8×10⁻⁵.

27. The optical pickup apparatus of any one of claims 1 to 26,
wherein at least one of the first objective optical system and the second objective optical system comprises a glass, and has an amount |dn/dT| of a change in a refractive index with a temperature change of less than 5×10⁻⁵.

28. An optical information recording and/or reproducing apparatus for an optical information medium, comprising an optical pickup apparatus,
wherein the optical pickup apparatus comprises:
a first light source for emitting a first light flux having a wavelength λ1;
a second light source for emitting a second light flux having a wavelength λ2 (λ2>λ1);
a third light source for emitting a third light flux having a wavelength λ3 (λ3>λ2);
a first objective optical system;
a second objective optical system;
an incidence optical system for emitting the first to third light fluxes into one of the first objective optical system and the second objective optical system; and
an optical detector,
wherein the first objective optical system is adopted to converge the first light flux with the wavelength λ1 emitted by the first light source onto an information recording surface of a first optical information recording medium having a first protective layer whose thickness is t1 so that the optical pickup apparatus conducts reproducing and/or recording information for the first optical information recording medium,
wherein the first objective optical system is adopted to converge the first light flux onto an information recording surface of a second optical information recording medium having a second protective layer whose thickness is t2 (t2>t1) so that the optical pickup apparatus conducts reproducing and/or recording information for the second optical information recording medium,
wherein the second objective optical system is adopted to converge the second light flux with the wavelength λ2 emitted by the second light source onto an information recording surface of a third optical information recording medium having a third protective layer whose thickness is t3 (t3>t1) so that the optical pickup apparatus conducts reproducing and/or recording information for the third optical information recording medium,
wherein the second objective optical system is adopted to converge the third light flux with the wavelength λ3 emitted by the third light flux onto an information recording surface of a fourth optical information recording medium having a fourth protective layer whose thickness is t4 (t4>t3) so that the optical pickup apparatus conducts reproducing and/or recording information for the fourth optical information recording medium,
wherein the first objective optical system comprises an objective lens, and a liquid crystal correction element being adopted to correct an amount of spherical aberration of a light flux passing through the liquid crystal correction element, and
wherein the incidence optical system comprises an optical element arranged statically along at least an optical axis.

29. An optical information recording and/or reproducing apparatus for an optical information medium, comprising an optical pickup apparatus,
wherein the optical pickup apparatus comprises:
a first light source for emitting a first light flux having a wavelength λ1;
a second light source for emitting a second light flux having a wavelength λ2 (λ2>λ1);
a third light source for emitting a third light flux having a wavelength λ3 (λ3>λ2);
a first objective optical system;
a second objective optical system;
an incidence optical system for emitting the first to third light fluxes into one the first objective optical system and the second objective optical system; and
an optical detector,
wherein the first objective optical system is adopted to converge the first light flux with the wavelength λ1 emitted by the first light source onto an information recording surface of a first optical information recording medium having a first protective layer whose thickness is t1 so that the optical pickup apparatus conducts reproducing and/or recording information for the first optical information recording medium,
wherein the first objective optical system is adopted to converge the first light flux onto an information recording surface of a second optical information recording medium having a second protective layer whose thickness is t2 (t2>t1) so that the optical pickup apparatus conducts reproducing and/or recording information for the second optical information recording medium,
wherein the second objective optical system is adopted to converge the second light flux with the wavelength λ2 emitted by the second light source onto an information recording surface of a third optical information recording medium having a third protective layer whose thickness is t3 (t3>t1) so that the optical pickup apparatus conducts reproducing and/or recording information for the third optical information recording medium,
wherein the second objective optical system is adopted to converge the third light flux with the wavelength λ3 emitted by the third light flux onto an information recording surface of a fourth optical information recording medium having a fourth protective layer whose thickness is t4 (t4>t3) so that the optical pickup apparatus conducts reproducing and/or recording information for the fourth optical information recording medium,
wherein the first objective optical system comprises an objective lens, and a liquid crystal correction element being adopted to correct an amount of spherical aberration of a light flux passing through the liquid crystal correction element, and
wherein the incidence optical system comprises a coupling lens which is movable along an optical axis and transmits a light flux prior to being collimated.
